(19) United States
(12) Patent Application Publication
(10) Pub. No.: US 2025/0373773 A1
(43) Pub. Date: Dec. 4, 2025

(54) HEAD-MOUNTED STEREOSCOPIC DISPLAY DEVICE WITH DIGITAL LOUPES AND ASSOCIATED METHODS

(71) Applicant: Augmedics Ltd., Yokneam Illit (IL)

(72) Inventors: Asaf ASABAN, Haifa (IL); Yaacov Hillel ROTHSCHILD, Kiryat Yearim (IL); Nissan ELIMELECH, Be'erotaim (IL); Stuart WOLF, Yokneam (IL)

(21) Appl. No.: 19/308,011

(22) Filed: Aug. 22, 2025

Related U.S. Application Data
(63) Continuation of application No. PCT/IB2024/051691, filed on Feb. 21, 2024.
(60) Provisional application No. 63/447,368, filed on Feb. 22, 2023.
(60) Provisional application No. 63/447,362, filed on Feb. 22, 2023.
(60) Provisional application No. 63/519,708, filed on Aug. 15, 2023.

(51) Int. Cl. H04N 13/167; H04N 13/00; H04N 13/239; H04N 13/344; H04N 13/383

(52) U.S. Cl. CPC H04N 13/167; H04N 13/239; H04N 13/344; H04N 13/383; H04N 2013/0081

(57) ABSTRACT

A head mounted display device (HMD) includes a display including a first display and a second display; a first and a second digital cameras, respectively including a first image sensor and a second image sensor; and at least one processor configured to: generate a first image and a second image from a first image region of the first image sensor and from a second image region of the second image sensor, respectively, wherein: the first image region corresponds to a first image AFOV, and the second image region corresponds to a second image AFOV; change at least one of the first image region of the first image sensor or the second image region of the second image sensor based on a distance between the HMD and a Region of Interest (ROI) plane; and simultaneously display the first image on the first display and the second image on the second display.

### CROSS-REFERENCE TO RELATED APPLICATIONS

This application is a continuation of PCT International Application PCT/IB2024/051691, filed Feb. 21, 2024, titled “Stereoscopic Display And Digital Loupe For Near-Eye Display,” which claims priority to U.S. Provisional Application No. 63/519,708, filed Aug. 15, 2023, titled “Stereoscopic Display And Digital Loupe For Near-Eye Display,” U.S. Provisional Application No. 63/447,362, filed Feb. 22, 2023, titled “Stereoscopic Display And Digital Loupe For Near-Eye Display,” and U.S. Provisional Application No. 63/447,368, filed Feb. 22, 2023, titled “Augmented-Reality Surgical System Using Depth Sensing,” the entire contents of each of which are hereby incorporated by reference.

### TECHNICAL FIELD

The present disclosure relates generally to head-mounted and/or near eye displays, and to systems and methods for stereoscopic display and digital magnification or other imaging or presentation alteration, modification and/or correction via head-mounted and/or near eye displays used in image-guided surgery, medical interventions, diagnosis or therapy.

### BACKGROUND

Medical practitioners use optical loupes to see a magnified image of a region of interest (ROI) during surgery and in other medical procedures. Traditionally, such optical loupes comprise magnifying optics, with fixed or variable magnification. A loupe may be, for example, integrated in a spectacle lens or may be movably mounted on a spectacle frame or on the user's head.

Near-eye display devices and systems can be used, for example, in augmented reality systems. When presenting images on a near eye display (e.g., video images or augmented reality images), it is highly advantageous to display the images in a stereoscopic manner.

See-through displays (e.g., displays including at least a portion which is see-through) are used in augmented reality systems, for example for performing image-guided and/or computer assisted surgery. Applicant's own work has demonstrated that such see-through displays can be presented as near eye displays, e.g., integrated in a Head Mounted Device (HMD). In this way, a computer-generated image may be presented to a healthcare professional who is performing a procedure, and, in some cases, such that the image is aligned with an anatomical portion of a patient who is undergoing the procedure. Systems for image-guided surgery are described, for example, in U.S. Pat. Nos. 9,928,629, 10,835,296, 10,939,977, PCT International Publication WO 2019/211741, U.S. Patent Application Publication 2020/0163723, and PCT International Publication WO 2022/053923. The disclosures of all these patents and publications are incorporated herein by reference.

### SUMMARY

Embodiments of the present disclosure provide systems and methods for presenting stereoscopic, augmented reality and/or magnified images on near eye displays. The systems and methods of the disclosure each have several innovative aspects, no single one of which is solely responsible for the desirable attributes disclosed herein.

In accordance with several embodiments, a head mounted display device (HMD) includes a see-through display, a plurality of video cameras configured to simultaneously capture an image including a region of interest (ROI) within a predefined field of view (FOV), and a distance sensor configured to measure the distance from the HMD to the ROI. The head-mounted display device also includes at least one processor configured to determine the distance from each of the video cameras to the ROI based on the measured distance from the HMD to the ROI, and adjust the display of each image of the images captured by the video cameras on the see through display based on the determined distances from the video cameras to provide an improved display on the see-through display.

In some embodiments, the plurality of video cameras includes two video cameras positioned symmetrically about a longitudinal plane of a wearer of the head-mounted unit such that the plurality of video cameras include a left video camera and a right video camera. Each of the left and right video cameras may include a sensor.

In some embodiments, the FOV is predefined for each of the left and right video cameras by determining a crop region on each sensor. In some embodiments, the crop regions of the sensors of the left and right video cameras are determined such that the left and right video cameras converge at a preselected distance from the HMD. In some embodiments, the crop regions of the sensors of the left and right video cameras are determined such that images captured by the left and right video cameras at a preselected distance from the HMD fully overlap.

In some embodiments, the distance sensor includes an infrared camera.

In some embodiments, the left and right video cameras each include a red-green-blue (RGB) video camera.

In some embodiments, the HMD is in the form of eyewear (e.g., goggles, glasses, spectacles, monocle, visor, head-up display, any other suitable type of displaying device mounted on or worn by any portion of a user or wearer's head, including but not limited to the face, crown, forehead, nose and ears).

In some embodiments, the HMD is in the form of a helmet or over-the-head mounted device.

In some embodiments, the at least one processor is further configured to discard non overlapping portions of the images. In some embodiments, the at least one processor is further configured to display only the overlapping portions of the images on the see-through display.

In some embodiments, the at least one processor is further configured to determine focus values corresponding to the determined distances and, for each determined distance, apply the corresponding focus value to the left and right video cameras.

In some embodiments, the at least one processor is further configured to determine a magnification value and to magnify the displayed images on the see-through display by the magnification value.

In some embodiments, the at least one processor is further configured to overlay augmented reality images on the magnified images displayed on the see-through display. The at least one processor may be further configured to magnify the overlaid augmented reality images on the see-through display by the magnification value.

In some embodiments, the augmented reality images include a 3D model of a portion of an anatomy of a patient generated from one or more pre-operative or intraoperative medical images of the portion of the anatomy of the patient (e.g., a portion of a spine of the patient, a portion of a knee of the patient, a portion of a leg or arm of the patient, a portion of a brane or cranium of the patient, a portion of a torso of the patient, a portion of a hip of the patient, a portion of a foot of the patient).

In some embodiments, the adjustment is a horizontal shift based on a horizontal shift value corresponding to the determined distances of the plurality of video cameras from the ROI.

In some embodiments, the left and right video cameras are disposed on a plane substantially parallel to a coronal plane and are positioned symmetrically with respect to a longitudinal plane. The coronal plane and the longitudinal plane may be defined with respect to a user wearing the HMD.

In some embodiments, the at least one processor is configured to determine horizontal shift values corresponding to the determined distance from the left video camera and from the right video camera to the ROI, and horizontally shift the display of each image of the images captured by the left and right video cameras on the see through display by the corresponding horizontal shift value.

In some embodiments, the see-through display includes a left see through display and a right see-through display that are together configured to provide a stereoscopic display.

In accordance with several embodiments, a method of providing an improved stereoscopic display on a see-through display of a head-mounted display device includes simultaneously capturing images on a left and a right video camera of the head-mounted display device. The images include a region of interest (ROI) within a field of view (FOV), such as a predefined FOV. The method further includes measuring a distance from the HMD to the ROI using a distance sensor mounted on or in the head-mounted display device. The method also includes determining a distance from each of the left and right video cameras to the ROI based on the measured distance from the HMD to the ROI. The method further includes adjusting the display of each image of the images captured by the left and right video cameras on the see through display of the head-mounted display device based on the determined distances from the left and right video cameras to provide the improved stereoscopic display on the see-through display.

The see-through display may include a left see-through display and a right see-through display. Each of the left and right video cameras may include a sensor. In some embodiments, the FOV is predefined for each of the left and right video cameras by determining a crop region on each sensor. In some embodiments, the crop regions of the sensors of the left and right video cameras are determined such that the left and right video cameras converge at a preselected distance from the HMD. In some embodiments, the crop regions of the sensors of the left and right video cameras are determined such that the images captured by the left and right video cameras at a preselected distance from the HMD fully overlap.

The distance sensor may include an infrared camera. The distance sensor may include a light source. The left and right video cameras may be red-green-blue (RGB) color video cameras.

The method may also include discarding overlapping portions of the images. The method may include displaying only the overlapping portions of the images on the see-through display.

In some embodiments, the method includes determining focus values corresponding to the determined distances and, for each determined distance, applying the corresponding focus value to the left and right video cameras.

In some embodiments, the method includes determining a magnification value and magnifying the displayed images on the see-through display by the magnification value.

In some embodiments, the method includes overlaying augmented reality images on the magnified images displayed on the see-through display. The method may also include magnifying the overlaid augmented reality images on the see-through display by the magnification value.

In some embodiments, the adjusting includes applying a horizontal shift based on a horizontal shift value corresponding to the determined distances of the left and right video cameras from the ROI.

The methods may be performed by one or more processors within the head-mounted display device or communicatively coupled to the head-mounted display device.

In accordance with several embodiments, an imaging apparatus for facilitating a medical procedure, such as a spinal surgery, includes a head-mounted unit including a see-through display and at least one video camera, which is configured to capture images of a field of view (FOV), having a first angular extent, that is viewed through the display by a user wearing the head-mounted unit and a processor configured to process the captured images so as to generate and present on the see-through display a magnified image of a region of interest (ROI) having a second angular extent within the FOV that is less than the first angular extent.

In some embodiments, the head-mounted unit comprises an eye tracker configured to identify a location of a pupil of an eye of the user wearing the head-mounted unit. In some embodiments, the processor is configured to generate the magnified image responsively to the location of the pupil. In some embodiments, the eye tracker is configured to identify respective locations of pupils of both a left eye and a right eye of the user. In some embodiments, the processor may be configured to measure an interpupillary distance responsively to the identified locations of the pupils via the eye tracker and to present respective left and right magnified images of the ROI on the see-through display responsively to the interpupillary distance.

In some embodiments, the magnified image presented by the processor comprises a stereoscopic image of the ROI. The at least one video camera may include left and right video cameras, which are mounted respectively in proximity to left and right eyes of the user. The processor may be configured to generate the stereoscopic image based on the images captured by both the left and right video cameras.

In some embodiments, the processor is configured to estimate a distance from the head-mounted unit to the ROI based on a disparity between the images captured by both the left and right video cameras, and to adjust the stereoscopic image responsively to the disparity.

In some embodiments, the see-through display includes left and right near-eye displays. The processor may be configured to generate the stereoscopic image by presenting respective left and right magnified images of the ROI on the left and right near-eye displays, while applying a horizontal shift to the left and right magnified images based on a distance from the head-mounted unit to the ROI.

In some embodiments, the head-mounted unit includes a tracking system configured to measure the distance from the head-mounted unit to the ROI. In some embodiments, the tracking system includes a distance sensor. The distance sensor may include an infrared camera.

In some embodiments, the processor is configured to measure the distance by identifying a point of contact between a tool held by the user and the ROI.

In some embodiments, the FOV comprises a part of a body of a patient undergoing a surgical procedure (e.g., an open surgical procedure or a minimally invasive interventional procedure).

In some embodiments, the processor is configured to overlay an augmented reality image on the magnified image of the ROI that is presented on the see-through display.

In accordance with several embodiments, a method for imaging includes capturing images of a field of view (FOV), having a first angular extent, using at least one video camera mounted on a head-mounted unit, which includes a see-through display through which a user wearing the head-mounted unit views the FOV. The method also includes processing the captured images so as to generate and present on the see-through display a magnified image of a region of interest (ROI) having a second angular extent within the FOV that is less than the first angular extent.

In some embodiments, the method includes identifying a location of a pupil of an eye of the user wearing the head-mounted unit, wherein processing the captured images comprises generating the magnified image responsively to the location of the pupil. In some embodiments, identifying the location includes identifying respective locations of pupils of both a left eye and a right eye of the user and measuring an interpupillary distance responsively to the identified locations of the pupils. In some embodiments, generating the magnified image comprises presenting respective left and right magnified images of the ROI on the see-through display with a horizontal shift applied to the left and right magnified images.

In some embodiments, the magnified image presented on the see-through display comprises a stereoscopic image of the ROI.

In some embodiments, capturing the images includes capturing left and right video images using left and right video cameras, respectively, mounted respectively in proximity to left and right eyes of the user, and processing the captured images comprises generating the stereoscopic image based on the images captured by both the left and right video cameras.

In some embodiments, the method includes estimating a distance from the head-mounted unit to the ROI based on a disparity between the images captured by both the left and right video cameras and adjusting the stereoscopic image responsively to the disparity.

In accordance with several embodiments, a computer software product, for use in conjunction with a head-mounted unit, which includes a see-through display and at least one video camera, which is configured to capture images of a field of view (FOV), having a first angular extent, that is viewed through the display by a user wearing the head-mounted unit, includes: a tangible, non-transitory computer-readable medium in which program instructions are stored, which instructions, when read by a processor, cause the processor to process the captured images so as to generate and present on the see-through display a magnified image of a region of interest (ROI) having a second angular extent within the FOV that is less than the first angular extent.

There is further provided, according to an embodiment of the present disclosure, a head mounted display device (HMD) including: a display including a first display and a second display; a first and a second digital cameras, respectively including a first image sensor and a second image sensor, and respectively having a first and a second predetermined angular fields of view (AFOVs), wherein the first and second digital cameras are being disposed in a predetermined fixed setup on a plane substantially parallel to a frontal plane of a head of a user wearing the HMD, the first and second digital cameras separated by a predetermined fixed separation defining one of the first or second digital cameras as a left camera and the other as a right camera with respect to the user; and at least one processor configured to: generate a first image and a second image from a first image region of the first image sensor and from a second image region of the second image sensor, respectively, wherein: the first image region corresponds to a first image AFOV, and the second image region corresponds to a second image AFOV, sizes of the first image AFOV and the second image AFOV are equal to a predefined image AFOV size smaller than a size of each of the first and second AFOVs, and the first image AFOV and the second image AFOV are symmetrical with respect to a longitudinal plane of the head of the user; obtain a distance between the HMD and a Region of Interest (ROI) plane, wherein the ROI plane is substantially parallel to the frontal plane; change at least one of the first image region of the first image sensor or the second image region of the second image sensor based on the obtained distance, so that for a first image and a second image generated based on the change from the first and second image regions, respectively, a portion of the ROI plane imaged by the first image is substantially identical to a portion of the ROI plane imaged by the second image; and simultaneously display the first image on the first display and the second image on the second display.

In a disclosed embodiment the HMD may include a distance sensor configured to measure the distance between the HMD and the ROI plane.

The distance sensor may include a camera configured to capture images of at least one optical marker located in the ROI plane or adjacent to it.

In a further disclosed embodiment obtaining the distance may include determining the distance based on analyzing one or more images of the ROI plane.

In an embodiment the at least one processor may be further configured to determine the change based on the image AFOV and the predetermined fixed separation.

In a further embodiment each of the first and second AFOVs may include the ROI plane.

In one embodiment the first and second digital cameras may be RGB cameras.

In a disclosed embodiment the first AFOV and the second AFOV may be of the same size.

In an alternative embodiment the first and second digital cameras setup is a parallel setup, such that an optical axis of the first digital camera and an optical axis of the second digital camera are parallel to a longitudinal plane of the head of the user.

In some embodiments, the first and second digital cameras are positioned in a toe-in arrangement, such that an optical axis of the first digital camera intersects an optical axis of the second digital camera. In some embodiments, the at least one processor is further configured to determine the change based at least partially on the distance between the HMD and the ROI plane and a cross-ratio function initialized by analyzing a target at multiple positions each a different distance from the first and second digital cameras.

In an embodiment the first image sensor and the second image sensor may be identical.

In a disclosed embodiment the first and second digital cameras are positioned symmetrically with respect to a longitudinal plane of the head of the user aligned with a midline of the head of the user.

In an embodiment the at least one processor is configured to change both the first image region and the second image region based on the obtained distance.

In one embodiment the change substantially simulates a rotation of at least one of the first image AFOV or the second image AFOV by an angular rotation, correspondingly.

The angular rotation may be a horizontal angular rotation.

In an alternative embodiment the change substantially simulates a rotation of the first image AFOV by a first horizontal angular rotation, and of the second image AFOV by a second horizontal angular rotation equal numerically and opposite in direction to the first horizontal angular rotation.

In an alternative embodiment a horizontal length of a changed first image region and of a changed second image region are numerically equal to a horizontal length of the first image region and the second image region before the change.

In a disclosed embodiment the size of a first image AFOV corresponding to a changed first image region and the size of a second image AFOV corresponding to a changed second image region are numerically equal to the size of the image AFOV of the first image region and the second image region before the change.

In an embodiment the at least one processor is further configured to iteratively obtain the distance, based on the obtained distance, iteratively change at least one of the first image region or the second image region and iteratively generate and display, based on the change, the first image and the second image from the first image region and the second image region, respectively.

In another embodiment at least a portion of the first display and of the second display is a see through display

In a further embodiment changing at least one of the first image region or the second image region includes horizontally shifting at least one of the first image region or the second image region.

The horizontal shifting may include changing the horizontal length of the at least one of the first image region or the second image region.

In an embodiment the HMD is used for surgery and the ROI plane includes at least a portion of a body of a patient.

In a disclosed embodiment the at least one processor is further configured to magnify the first image and the second image by an input ratio and display the magnified first and second images on the first and second displays, respectively.

The magnification may include down sampling of the first and second images.

In some embodiments, the at least one processor is further configured to cause at least one of visibility or clarity of reality through the first and second displays to be reduced when the magnified first and second images are displayed.

In some embodiments, the HMD further comprises one or more removably couplable neutral density filters configured to reduce transmission of environmental light through the first and second displays when coupled thereto.

There is further provided, according to an embodiment of the present disclosure, a method for displaying stereoscopic images on a head mounted display device (HMD), the HMD including a first and a second digital cameras, respectively including a first image sensor and a second image sensor, and respectively having a first and a second predetermined angular fields of view (AFOVs), the method including: generating a first image and a second image from a first image region of the first image sensor and from a second image region of the second image sensor, respectively, wherein: the first image region corresponds to a first image AFOV, and the second image region corresponds to a second image AFOV, sizes of the first image AFOV and the second image AFOV are equal to a predefined image AFOV size smaller than a size of each of the first and second AFOVs, and the first image AFOV and the second image AFOV are symmetrical with respect to a longitudinal plane of a head of a user wearing the HMD; obtaining a distance between the HMD and a Region of Interest (ROI) plane, wherein the ROI plane is substantially parallel to the frontal plane; changing at least one of the first image region of the first image sensor or the second image region of the second image sensor based on the obtained distance, so that for a first image and a second image generated based on the change from the first and second image regions, respectively, a portion of the ROI plane imaged by the first image is substantially identical to a portion of the ROI plane imaged by the second image; and simultaneously displaying the first image on a first display of the HMD and the second image on a second display of the HMD, wherein the first and second digital cameras are being disposed in a predetermined fixed setup on a plane substantially parallel to a frontal plane of the head of the user, the first and second digital cameras separated by a predetermined fixed separation defining one of the first or second digital cameras as a left camera and the other as a right camera with respect to the user.

In some embodiments, the HMD further comprises a distance sensor configured to measure the distance between the HMD and the ROI plane. In some embodiments, the distance sensor comprises a camera configured to capture images of at least one optical marker located in the ROI plane or adjacent to it. In some embodiments, the obtaining of the distance comprises determining the distance based on analyzing one or more images of the ROI plane. In some embodiments, changing at least one of the first image region or the second image region is further based on the image AFOV and the predetermined fixed separation. In some embodiments, each of the first and second AFOVs includes the ROI plane. In some embodiments, the first and second digital cameras are RGB cameras. In some embodiments, the first AFOV and the second AFOV are of the same size. In some embodiments, the first and second digital cameras setup is a parallel setup, such that an optical axis of the first digital camera and an optical axis of the second digital camera are parallel to a longitudinal plane of the head of the user. In some embodiments, the first and second digital cameras are positioned in a toe-in arrangement, such that an optical axis of the first digital camera intersects an optical axis of the second digital camera. In some embodiments, changing at least one of the first image region or the second image region is further based at least partially on the distance between the HMD and the ROI plane and a cross-ratio function initialized by analyzing a target at multiple positions each a different distance from the first and second digital cameras. In some embodiments, the first image sensor and the second image sensor are identical. In some embodiments, the first and second digital cameras are positioned symmetrically with respect to a longitudinal plane of the head of the user aligned with a midline of the head of the user. In some embodiments, changing at least one of the first image region or the second image region comprises changing both the first image region and the second image region based on the obtained distance. In some embodiments, changing at least one of the first image region or the second image region substantially simulates a rotation of at least one of the first image AFOV or the second image AFOV by an angular rotation, correspondingly. In some embodiments, the angular rotation is a horizontal angular rotation. In some embodiments, changing at least one of the first image region or the second image region substantially simulates a rotation of the first image AFOV by a first horizontal angular rotation, and of the second image AFOV by a second horizontal angular rotation equal numerically and opposite in direction to the first horizontal angular rotation. In some embodiments, changing at least one of the first image region or the second image region does not comprise changing a horizontal length of the first image region or of the second image region. In some embodiments, changing at least one of the first image region or the second image region does not comprise changing the size of the image AFOV corresponding to the first image region or of the second image region, respectively. In some embodiments, the method further comprises: iteratively obtaining the distance; based on the obtained distance, iteratively changing at least one of the first image region or the second image region; and iteratively generating and displaying, based on the change, the first image and the second image from the first image region and the second image region, respectively. In some embodiments, at least a portion of the first display and of the second display is a see through display. In some embodiments, changing at least one of the first image region or the second image region comprises horizontally shifting at least one of the first image region or the second image region. In some embodiments, the horizontal shifting comprises changing a horizontal length of the at least one of the first image region or the second image region. In some embodiments, the HMD is used for performing medical operations and wherein the ROI plane comprises at least a portion of the body of a patient. In some embodiments, the method further comprises magnifying the first image and the second image by an input ratio and displaying the magnified first and second images on the first and second displays, respectively. In some embodiments, the magnification comprises down sampling of the first and second images. In some embodiments, the method further comprises causing at least one of visibility or clarity of reality through the first and second displays to be reduced when the magnified first and second images are displayed.

There is further provided, according to an embodiment of the present disclosure, a head mounted display device (HMD) including: a display including a first display and a second display; a first and a second digital cameras, respectively including a first image sensor and a second image sensor, and respectively having a first and a second predetermined angular fields of view (AFOVs), wherein the first and second digital cameras are being disposed in a predetermined fixed setup on a plane substantially parallel to a frontal plane of a head of a user wearing the HMD, the first and second digital cameras separated by a predetermined fixed separation defining one of the first or second digital cameras as a left camera and the other as a right camera with respect to the user; and at least one processor configured to: generate a first image and a second image from a first image region of the first image sensor and from a second image region of the second image sensor, respectively, wherein: the first image region corresponds to a first image AFOV, and the second image region corresponds to a second image AFOV, the sizes of the first image AFOV and the second image AFOV are equal to a predefined image AFOV size smaller than the size of each of the first and second AFOVs, and the first image AFOV and the second image AFOV are symmetrical with respect to a longitudinal plane of the user's head; obtain a distance between the HMD and a Region of Interest (ROI) plane, wherein the ROI plane is substantially parallel to the frontal plane; based on the obtained distance, horizontally shift the first image region on the first image sensor and the second image region on the second image sensor, so that the intersection line of the horizontal first image AFOV with the ROI plane is identical to the intersection line of the horizontal second image AFOV with the ROI plane, wherein the horizontal first image AFOV is the horizontal portion of the first image AFOV and the horizontal second image AFOV is the horizontal portion of the second image AFOV with respect to the user's head; and simultaneously display the first image on the first see-through display and the second image on the second sec-through display.

In some embodiments, the HMD further comprises a distance sensor configured to measure the distance between the HMD and the ROI plane. In some embodiments, the distance sensor comprises a camera configured to capture images of at least one optical marker located in the ROI plane or adjacent to it. In some embodiments, the obtaining of the distance comprises determining the distance based on analyzing one or more images of the ROI plane. In some embodiments, the at least one processor is further configured to determine the shift based on the image AFOV and the predetermined separation. In some embodiments, each of the first and second AFOVs includes the ROI. In some embodiments, the digital cameras are RGB cameras. In some embodiments, the first AFOV and the second AFOV are of the same size. In some embodiments, the first and second digital cameras setup is a parallel setup, such that the optical axis of the first digital camera and the optical axis of the second digital camera are parallel to a longitudinal plane of the user's head. In some embodiments, the first and second digital cameras are positioned in a toe-in arrangement, such that an optical axis of the first digital camera intersects an optical axis of the second digital camera. In some embodiments, the at least one processor is further configured to determine the shift based at least partially on the distance between the HMD and the ROI plane and a cross-ratio function initialized by analyzing a target at multiple positions each a different distance from the first and second digital cameras. In some embodiments, the first image sensor and the second image sensor are identical. In some embodiments, the first and second digital cameras are positioned symmetrically with respect to a longitudinal plane of the user's head aligned with the midline of the user's head. In some embodiments, the shift substantially simulates a rotation of the first image AFOV and of the second image AFOV by a horizontal angular rotation. In some embodiments, the shift substantially simulates a rotation of the first image AFOV by a first horizontal angular rotation, and of the second image AFOV by a second horizontal angular rotation equal numerically and opposite in direction to the first horizontal angular rotation. In some embodiments, the horizontal length of a shifted first image region and of a shifted second image region are numerically equal to the horizontal length of the first image region and of the second image region before the shift, respectively. In some embodiments, the size of the first image AFOV corresponding to a shifted first image region and the size of the second image AFOV corresponding to a shifted second image region are numerically equal to the size of the first image AFOV and of the second image AFOV before the shift, respectively. In some embodiments, the at least one processor is further configured to iteratively obtain the distance, based on the obtained distance, iteratively shift the first image region and the second image region, and iteratively generate and display, based on the shift, the first image and the second image from the first image region and the second image region, respectively. In some embodiments, at least a portion of the first display and of the second display is a see through display. In some embodiments, the horizontal shifting comprises changing the horizontal length of the first image region and of the second image region. In some embodiments, the HMD is used for a medical operation and wherein the ROI comprises at least a portion of the body of a patient. In some embodiments, the at least one processor is further configured to magnify the first image and the second image by an input ratio and display the magnified first and second images on the first and second displays, respectively. In some embodiments, the magnification comprises down sampling of the first and second images. In some embodiments, the at least one processor is further configured to cause at least one of visibility or clarity of reality through the first and second displays to be reduced when the magnified first and second images are displayed. In some embodiments, the HMD further comprising one or more removably couplable neutral density filters configured to reduce transmission of environmental light through the first and second displays when coupled thereto.

There is further provided, according to an embodiment of the present disclosure, a method for displaying stereoscopic images on a head mounted display device (HMD), the HMD including a first and a second digital cameras, respectively including a first image sensor and a second image sensor, and respectively having a first and a second predetermined angular fields of view (AFOVs), the method including: generating a first image and a second image from a first image region of the first image sensor and from a second image region of the second image sensor, respectively, wherein: the first image region corresponds to a first image AFOV, and the second image region corresponds to a second image AFOV, the sizes of the first image AFOV and the second image AFOV are equal to a predefined image AFOV size smaller than the size of each of the first and second AFOVs, and the first image AFOV and the second image AFOV are symmetrical with respect to a longitudinal plane of a head of a user wearing the HMD; obtaining a distance between the HMD and a plane of a Region of Interest (ROI), wherein the ROI plane is substantially parallel to the frontal plane; changing at least one of the first image region of the first image sensor or the second image region of the second image sensor based on the obtained distance, so that for a first image and a second image generated based on the change from the first and second image regions, respectively, the portion of the ROI plane imaged by the first image is substantially identical to the portion of the ROI plane imaged by the second image; and simultaneously displaying the first image on a first display of the HMD and the second image on a second display of the HMD, wherein the first and second digital cameras are being disposed in a predetermined fixed setup on a plane substantially parallel to a frontal plane of the user's head, the first and second digital cameras separated by a predetermined fixed separation defining one of the first or second digital cameras as a left camera and the other as a right camera with respect to the user.

In some embodiments, the HMD further comprises a distance sensor configured to measure the distance between the HMD and the ROI plane. In some embodiments, the distance sensor comprises a camera configured to capture images of at least one optical marker located in the ROI or adjacent to it. In some embodiments, the obtaining of the distance comprises determining the distance based on analyzing one or more images of the ROI. In some embodiments, shifting the first image region and the second image region is further based on the image AFOV and the predetermined separation. In some embodiments, each of the first and second AFOVs includes the ROI. In some embodiments, the digital cameras are RGB cameras. In some embodiments, the first AFOV and the second AFOV are of the same size. In some embodiments, the first and second digital cameras setup is a parallel setup, such that the optical axis of the first digital camera and the optical axis of the second digital camera are parallel to a longitudinal plane of the user's head. In some embodiments, the first and second digital cameras are positioned in a toe-in arrangement, such that an optical axis of the first digital camera intersects an optical axis of the second digital camera. In some embodiments, shifting the first image region and the second image region is further based at least partially on the distance between the HMD and the ROI plane and a cross-ratio function initialized by analyzing a target at multiple positions each a different distance from the first and second digital cameras. In some embodiments, the first image sensor and the second image sensor are identical. In some embodiments, the first and second digital cameras are positioned symmetrically with respect to a longitudinal plane of the user's head aligned with the midline of the user's head. In some embodiments, horizontally shifting the first image region and the second image region substantially simulates a horizontal rotation of the first image AFOV and of the second image AFOV by a horizontal angular rotation, correspondingly. In some embodiments, shifting the first image region and the second image region substantially simulates a rotation of the first image AFOV by a first horizontal angular rotation, and of the second image AFOV by a second horizontal angular rotation equal numerically and opposite in direction to the first horizontal angular rotation. In some embodiments, shifting the first image region and the second image region does not comprise changing the horizontal length of the first image region and of the second image region. In some embodiments, shifting the first image region and the second image region does not comprise changing the size of the first image AFOV corresponding to the first image region and of the second image AFOV corresponding to the second image region. In some embodiments, the method further comprises: iteratively obtaining the distance; based on the obtained distance, iteratively shifting the first image region and the second image region; and iteratively generating and displaying, based on the shift, the first image and the second image from the first image region and from the second image region, respectively. In some embodiments, at least a portion of the first display and of the second display is a see through display. In some embodiments, the horizontal shifting comprises changing the horizontal length of the first image region or of the second image region. In some embodiments, the HMD is used for performing medical operations and wherein the ROI comprises at least a portion of the body of a patient. In some embodiments, the method further comprises magnifying the first image and the second image by an input ratio and displaying the magnified first and second images on the first and second displays, respectively. In some embodiments, the magnification comprises down sampling of the first and second images. In some embodiments, the method further comprises causing at least one of visibility or clarity of reality through the first and second displays to be reduced when the magnified first and second images are displayed.

There is further provided, according to an embodiment of the present disclosure, a head mounted display device (HMD) including: a see-through display including a left see-through display and a right see-through display; left and right digital cameras, separated by a predefined fixed separation and having common predefined angular fields of view (AFOVs), and respectively having a left image sensor and a right image sensor, and being disposed on a plane substantially parallel to a coronal plane and positioned symmetrically with respect to a longitudinal plane, wherein the coronal plane and the longitudinal plane are of a head of a user wearing the HMD, and wherein each of the left and right digital cameras is configured to simultaneously capture with a first region of the left image sensor and a second region of the right image sensor an image of a planar field of view (FOV), the planar FOV being formed in response to the AFOVs intersecting an imaged plane substantially parallel to the coronal plane; and at least one processor configured to: horizontally shift the first region of the left image sensor and the second region of the right image sensor by a common shift, so that respective shifted left and shifted right images generated by the shifted first region and shifted second region are substantially identical and include respective shifted portions of the planar FOV, and present the shifted left image on the left sec-through display and the shifted right image on the right sec-through display.

In some embodiments, the HMD comprises a distance sensor configured to measure a distance from the HMD to the planar FOV, and wherein the at least one processor is configured to determine bounds of the planar FOV in response to the distance. In some embodiments, the at least one processor is configured to determine bounds of the shifted portions of the planar FOV in response to the distance and the predefined separation. In some embodiments, the at least one processor is configured to determine the common shift in response to the distance. In some embodiments, the common shift rotates the AFOV of the left digital camera by a first angular rotation, and the AFOV of the right digital camera by a second angular rotation equal numerically and opposite in direction to the first angular rotation. In some embodiments, the AFOV of the left digital camera and of the right digital camera after the first and the second angular rotations is numerically equal to the AFOV of the left digital camera and of the right digital camera before the angular rotations. In some embodiments, the planar FOV comprises a left planar FOV formed in response to the AFOV of the left digital camera intersecting the imaged plane and a right planar FOV formed in response to the AFOV of the right digital camera intersecting the imaged plane, and wherein a left metric defining a length of the left planar FOV is numerically equal to a right metric defining a length of the right planar FOV.

According to some embodiments, a method for displaying stereoscopic images on a head mounted display device (HMD), the HMD comprising left and right digital cameras having common predefined angular fields of view (AFOVs), and respectively having a left image sensor and a right image sensor, and a see through display, wherein each of the left and right digital cameras is configured to simultaneously capture with a first region of the left image sensor and a second region of the right image sensor an image of a planar field of view (FOV), the planar FOV being formed in response to the AFOVs intersecting an imaged plane substantially parallel to the coronal plane, comprises: horizontally shifting the first region of the left image sensor and the second region of the right image sensor by a common shift, so that respective shifted left and shifted right images generated by the shifted first region and shifted second region are substantially identical and comprise respective shifted portions of the planar FOV, and presenting the shifted left image on a left see-through display of the see through display and the shifted right image on a right see-through display of the see through display, wherein the left and right digital cameras are separated by a predefined fixed separation and being disposed on a plane substantially parallel to a coronal plane and positioned symmetrically with respect to a longitudinal plane, and wherein the coronal plane and the longitudinal plane are of a head of a user wearing the HMD.

In some embodiments, the HMD further comprises a distance sensor configured to measure the distance from the HMD to the planar FOV, and wherein the method further comprises determining bounds of the planar FOV in response to the distance. In some embodiments, the determining of the bounds of the shifted portions of the planar FOV is in response to the distance and the predefined separation. In some embodiments, the method further comprises determining the common shift in response to the distance. In some embodiments, the common shift rotates the AFOV of the left video digital camera by a first angular rotation, and the AFOV of the right video digital camera by a second angular rotation equal numerically and opposite in direction to the first angular rotation. In some embodiments, the AFOV of the left digital camera and of the right digital camera after the first and the second angular rotations is numerically equal to the AFOV of the left digital camera and of the right digital camera before the angular rotations. In some embodiments, the planar FOV comprises a left planar FOV formed in response to the AFOV of the left digital camera intersecting the imaged plane and a right planar FOV formed in response to the AFOV of the right digital camera intersecting the imaged plane, and wherein a left metric defining a length of the left planar FOV is numerically equal to a right metric defining a length of the right planar FOV.

According to some embodiments, a head-mounted display device (HMD) comprises: a stereoscopic display comprising a left see-through display and a right see-through display, the stereoscopic display having an adjustable display parameter that affects at least one of visibility or clarity of reality through the stereoscopic display with respect to images displayed on the stereoscopic display; a first digital camera; a second digital camera; and at least one processor configured to: obtain a distance between the HMD and a Region of Interest (ROI) plane; based on the obtained distance and a desired level of magnification, generate a left image from the first digital camera for display on the left see-through display and a right image from the second digital camera for display on the right see-through display; in a first magnification mode, cause display of the generated left image and right image on the stereoscopic display using a first configuration of the adjustable display parameter; and in a second magnification mode, wherein the desired level of magnification is higher than in the first magnification mode, cause display of the generated left image and right image on the stereoscopic display using a second configuration of the adjustable display parameter, wherein the second configuration of the adjustable display parameter causes the at least one of visibility or clarity of reality through the stereoscopic display with respect to images displayed on the stereoscopic display to be lower than with the first configuration of the adjustable display parameter.

In some embodiments, the desired level of magnification in the first magnification mode is no magnification. In some embodiments, the adjustable display parameter comprises a level of brightness of the displayed generated left image and right image on the stereoscopic display. In some embodiments, the at least one processor is further configured to detect a level of brightness at or near the ROI plane and, in the second magnification mode, set the second configuration of the adjustable display parameter such that the level of brightness of the displayed generated left image and right image on the stereoscopic display is higher than the detected level of brightness at or near the ROI plane. In some embodiment, the detection of the level of brightness at or near the ROI plane includes analyzing output from at least one of the first digital camera or the second digital camera. In some embodiment, the HMD further comprises an ambient light sensor, and wherein the detection of the level of brightness at or near the ROI plane includes utilizing output from the ambient light sensor. In some embodiment, the adjustable display parameter comprises a level of opaqueness of the left and right see-through displays, and wherein the second configuration of the adjustable display parameter comprises a higher level of opaqueness than the first configuration of the adjustable display parameter. In some embodiment, each of the left and right see-through displays comprises an electrically switchable smart glass material. In some embodiment, the electrically switchable smart glass material comprises at least one of a polymer dispersed liquid crystal (PDLC) film, an electrochromic film, or micro-blinds. In some embodiment, the adjustable display parameter comprises a focal distance of the displayed generated left image and right image on the stereoscopic display. In some embodiment, the at least one processor is configured to determine a focal distance of the ROI plane based on the obtained distance between the HMD and the ROI plane, and wherein the second configuration of the adjustable display parameter comprises a focal distance having a greater disparity from the determined focal distance of the ROI plane than the first configuration of the adjustable display parameter. In some embodiment, the at least one processor is configured to adjust the focal distance of the displayed generated left image and right image on the stereoscopic display by at least one of: adjusting which regions of image sensors of the first and second digital cameras are used for the generated images or adjusting where the generated images are displayed on the stereoscopic display. In some embodiment, the HMD further comprises a distance sensor configured to measure the distance between the HMD and the ROI plane. In some embodiment, the distance sensor comprises a camera configured to capture images of at least one optical marker located in or adjacent to the ROI plane. In some embodiment, the at least one processor is configured to obtain the distance between the HMD and the ROI plane by at least analyzing one or more images of the ROI plane.

According to some embodiments, an augmented reality surgical display device with selectively activatable magnification comprises: a see-through display, the sec-through display having an adjustable display parameter that affects at least one of visibility or clarity of reality through the see-through display with respect to images displayed on the see-through display; a digital camera; and at least one processor configured to: obtain a distance between the augmented reality surgical display device and a Region of Interest (ROI); obtain a desired level of magnification; responsive to the desired level of magnification being no magnification, and based on the obtained distance, generate a first image from the digital camera, and cause the generated first image to be displayed on the see-through display using a first configuration of the adjustable display parameter and without magnification with respect to the ROI; and responsive to the desired level of magnification being greater than 1× magnification, and based on the obtained distance, generate a second image from the digital camera, and cause the generated second image to be displayed on the see-through display using a second configuration of the adjustable display parameter and with the desired level of magnification with respect to the ROI, wherein the second configuration of the adjustable display parameter causes the at least one of visibility or clarity of reality through the see-through display with respect to images displayed on the see-through display to be lower than with the first configuration of the adjustable display parameter.

In some embodiments, the adjustable display parameter comprises a relative level of brightness of an image displayed on the see-through display with respect to a level of brightness of reality through the see-through display. In some embodiments, the at least one processor is further configured to detect a level of brightness at or near the ROI, and to set the second configuration of the adjustable display parameter such that the relative level of brightness of an image displayed on the see-through display is higher than the detected level of brightness at or near the ROI. In some embodiments, the detection of the level of brightness at or near the ROI includes analyzing output from the digital camera. In some embodiments, the augmented reality surgical display device further comprises an ambient light sensor, and wherein the detection of the level of brightness at or near the ROI includes utilizing output from the ambient light sensor. In some embodiments, the adjustable display parameter comprises a level of opaqueness of the sec-through display, and wherein the second configuration of the adjustable display parameter comprises a higher level of opaqueness than the first configuration of the adjustable display parameter. In some embodiments, the see-through display comprises an electrically switchable smart glass material. In some embodiments, the electrically switchable smart glass material comprises at least one of a polymer dispersed liquid crystal (PDLC) film, an electrochromic film, or micro-blinds. In some embodiments, the see-through display is a first see-through display, and the augmented reality surgical display device further comprises a second see-through display, the first and second see-through displays together forming a stereoscopic see-through display, and wherein the adjustable display parameter comprises a focal distance of images displayed on the stereoscopic display. In some embodiments, the at least one processor is configured to determine a focal distance of the ROI based on the obtained distance between the augmented reality surgical display device and the ROI, and wherein the second configuration of the adjustable display parameter comprises a focal distance having a greater disparity from the determined focal distance of the ROI than the first configuration of the adjustable display parameter. In some embodiments, the at least one processor is configured to adjust the focal distance of images displayed on the stereoscopic display by at least one of: adjusting which region of an image sensor of the digital camera is used or adjusting where images are displayed on the stereoscopic display. In some embodiments, the augmented reality surgical display device further comprises a distance sensor configured to measure the distance between the augmented reality surgical display device and the ROI. In some embodiments, the distance sensor comprises a camera configured to capture images of at least one optical marker located in or adjacent to the ROI. In some embodiments, the at least one processor is configured to obtain the distance between the augmented reality surgical display device and the ROI by at least analyzing one or more images of the ROI.

According to some embodiments, a method for selectively obscuring reality on a head-mounted display device (HMD) comprises: providing an HMD comprising a stereoscopic display comprising a left see-through display and a right see-through display, the stereoscopic display having an adjustable display parameter that affects at least one of visibility or clarity of reality through the stereoscopic display with respect to images displayed on the stereoscopic display; a first digital camera; a second digital camera; and at least one processor; obtaining a distance between the HMD and a Region of Interest (ROI) plane; based on the obtained distance and a desired level of magnification, generating a left image from the first digital camera for display on the left see-through display and a right image from the second digital camera for display on the right sec-through display; in a first magnification mode, causing display of the generated left image and right image on the stereoscopic display using a first configuration of the adjustable display parameter; and in a second magnification mode, wherein the desired level of magnification is higher than in the first magnification mode, causing display of the generated left image and right image on the stereoscopic display using a second configuration of the adjustable display parameter, wherein the second configuration of the adjustable display parameter causes the at least one of visibility or clarity of reality through the stereoscopic display with respect to images displayed on the stereoscopic display to be lower than with the first configuration of the adjustable display parameter.

In some embodiments, the desired level of magnification in the first magnification mode is no magnification. In some embodiments, the adjustable display parameter comprises a level of brightness of the displayed generated left image and right image on the stereoscopic display. In some embodiments, the method further comprises: detecting a level of brightness at or near the ROI plane; and in the second magnification mode, setting the second configuration of the adjustable display parameter such that the level of brightness of the displayed generated left image and right image on the stereoscopic display is higher than the detected level of brightness at or near the ROI plane. In some embodiments, the detecting the level of brightness at or near the ROI plane includes analyzing output from at least one of the first digital camera or the second digital camera. In some embodiments, the detecting the level of brightness at or near the ROI plane includes utilizing output from an ambient light sensor of the HMD. In some embodiments, the adjustable display parameter comprises a level of opaqueness of the left and right see-through displays, and wherein the second configuration of the adjustable display parameter comprises a higher level of opaqueness than the first configuration of the adjustable display parameter. In some embodiments, the adjustable display parameter comprises a focal distance of the displayed generated left image and right image on the stereoscopic display. In some embodiments, the method further comprises: determining a focal distance of the ROI plane based on the obtained distance between the HMD and the ROI plane, and wherein the second configuration of the adjustable display parameter comprises a focal distance having a greater disparity from the determined focal distance of the ROI plane than the first configuration of the adjustable display parameter. In some embodiments, the method further comprises: adjusting the focal distance of the displayed generated left image and right image on the stereoscopic display by at least one of: adjusting which regions of image sensors of the first and second digital cameras are used for the generated images or adjusting where the generated images are displayed on the stereoscopic display. In some embodiments, the method further comprises measuring the distance between the HMD and the ROI plane using a distance sensor. In some embodiments, the method further comprises obtaining the distance between the HMD and the ROI plane by at least analyzing one or more images of the ROI plane.

According to some embodiments, a method for selectively obscuring reality on an augmented reality surgical display device with selectively activatable magnification comprises: providing an augmented reality surgical display device comprising a see-through display, the sec-through display having an adjustable display parameter that affects at least one of visibility or clarity of reality through the see-through display with respect to images displayed on the sec-through display; a digital camera; and at least one processor; obtaining a distance between the augmented reality surgical display device and a Region of Interest (ROI); obtaining a desired level of magnification; responsive to the desired level of magnification being no magnification, and based on the obtained distance, generating a first image from the digital camera, and causing the generated first image to be displayed on the see-through display using a first configuration of the adjustable display parameter and without magnification with respect to the ROI; and responsive to the desired level of magnification being greater than 1× magnification, and based on the obtained distance, generating a second image from the digital camera, and causing the generated second image to be displayed on the see-through display using a second configuration of the adjustable display parameter and with the desired level of magnification with respect to the ROI, wherein the second configuration of the adjustable display parameter causes the at least one of visibility or clarity of reality through the see-through display with respect to images displayed on the sec-through display to be lower than with the first configuration of the adjustable display parameter.

In some embodiments, the adjustable display parameter comprises a relative level of brightness of an image displayed on the see-through display with respect to a level of brightness of reality through the see-through display. In some embodiments, the method further comprises: detecting a level of brightness at or near the ROI; and setting the second configuration of the adjustable display parameter such that the relative level of brightness of an image displayed on the see-through display is higher than the detected level of brightness at or near the ROI. In some embodiments, the detecting the level of brightness at or near the ROI includes analyzing output from the digital camera. In some embodiments, the detecting the level of brightness at or near the ROI includes utilizing output from an ambient light sensor. In some embodiments, the adjustable display parameter comprises a level of opaqueness of the see-through display, and wherein the second configuration of the adjustable display parameter comprises a higher level of opaqueness than the first configuration of the adjustable display parameter. In some embodiments, the sec-through display is a first see-through display, and the augmented reality surgical display device further comprises a second see-through display, the first and second see-through displays together forming a stereoscopic sec-through display, and wherein the adjustable display parameter comprises a focal distance of images displayed on the stereoscopic display. In some embodiments, the method further comprises: determining a focal distance of the ROI based on the obtained distance between the augmented reality surgical display device and the ROI, and wherein the second configuration of the adjustable display parameter comprises a focal distance having a greater disparity from the determined focal distance of the ROI than the first configuration of the adjustable display parameter. In some embodiments, the method further comprises: adjusting the focal distance of images displayed on the stereoscopic display by at least one of: adjusting which region of an image sensor of the digital camera is used or adjusting where images are displayed on the stereoscopic display. In some embodiments, the method further comprises measuring the distance between the augmented reality surgical display device and the ROI using a distance sensor. In some embodiments, the method further comprises obtaining the distance between the augmented reality surgical display device and the ROI by at least analyzing one or more images of the ROI.

According to some embodiments, a head mounted display device (HMD) comprises: a display comprising a left see-through display and a right see-through display; a left digital camera and a right digital camera, separated by a predefined fixed separation and having common predefined angular fields of view (AFOVs), and respectively having a left image sensor and a right image sensor, wherein the left digital camera and the right digital camera are configured to be disposed on a plane substantially parallel to a coronal plane of a head of a user wearing the HMD, and configured to be positioned symmetrically with respect to a longitudinal plane of the head of the user wearing the HMD, and wherein the left digital camera is configured to capture images of a planar field of view (FOV) with a first region of the left image sensor, and the right digital camera is configured to capture images of the planar FOV with a second region of the right image sensor, the planar FOV being formed by the AFOVs intersecting an imaged plane substantially parallel to the coronal plane; and at least one processor configured to: obtain a distance from the HMD to the planar FOV; determine bounds of the planar FOV based at least partially on the distance from the HMD to the planar FOV; horizontally shift the first region of the left image sensor and the second region of the right image sensor by a common shift, so that respective shifted left and shifted right images generated by the shifted first region and shifted second region are substantially identical and comprise respective shifted portions of the planar FOV, and present the shifted left image on the left see-through display and the shifted right image on the right see-through display.

In some embodiments, the shifted first region corresponds to a first image AFOV and the shifted second region corresponds to a second image AFOV, and wherein sizes of the first image AFOV and the second image AFOV are smaller than a size of the common predefined AFOV. In some embodiments, the horizontal shift of the first region of the left image sensor and the second region of the right image sensor is such that an intersection line of a horizontal first image AFOV with the planar FOV is identical to an intersection line of a horizontal second image AFOV with the planar FOV, wherein the horizontal first image AFOV is the horizontal portion of the first image AFOV and the horizontal second image AFOV is the horizontal portion of the second image AFOV. In some embodiments, the at least one processor is configured to obtain the distance from the HMD to the planar FOV by at least one of: analyzing disparity between images from the left digital camera and the right digital camera; computing the distance based on a focus of the left digital camera or the right digital camera; analyzing one or more images of at least one optical marker located in or adjacent to the planar FOV; or based on signals provided by one or more eye trackers, comparing gaze angles of left and right eyes of the user to find a distance at which the eyes converge. In some embodiments, the HMD further comprises a distance sensor for measuring the distance from the HMD to the planar FOV, wherein the distance sensor comprises at least one of: a camera configured to capture images of at least one optical marker; or a depth sensor configured to illuminate the planar FOV with a pattern of structured light and analyze an image of the pattern on the planar FOV. In some embodiments, the at least one processor is configured to determine the common shift based at least partially on the distance from the HMD to the planar FOV. In some embodiments, the at least one processor is further configured to magnify the shifted first image and the shifted second image by an input ratio and present the magnified shifted first and second images on the left and right see-through displays, respectively. In some embodiments, the at least one processor is further configured to cause at least one of visibility or clarity of reality through the left and right see-through displays to be reduced when the magnified shifted first and second images are presented. In some embodiments, the HMD further comprises one or more removably couplable neutral density filters configured to reduce transmission of environmental light through the left and right see-through displays when coupled thereto. In some embodiments, the left and right digital cameras are positioned in a parallel arrangement, such that an optical axis of the left digital camera and an optical axis of the right digital camera are configured to be parallel to a longitudinal plane of the head of the user. In some embodiments, the left and right digital cameras are positioned in a toe-in arrangement, such that an optical axis of the left digital camera intersects an optical axis of the right digital camera. In some embodiments, the at least one processor is configured to determine the common shift based at least partially on the distance from the HMD to the planar FOV and a cross-ratio function initialized by analyzing a target at multiple positions each a different distance from the left and right digital cameras. In some embodiments, the common shift rotates the AFOV of the left digital camera by a first angular rotation, and the AFOV of the right digital camera by a second angular rotation equal numerically and opposite in direction to the first angular rotation. In some embodiments, the AFOV of the left digital camera and of the right digital camera after the first and the second angular rotations is numerically equal to the AFOV of the left digital camera and of the right digital camera before the angular rotations. In some embodiments, the planar FOV comprises a left planar FOV formed in response to the AFOV of the left digital camera intersecting the imaged plane and a right planar FOV formed in response to the AFOV of the right digital camera intersecting the imaged plane, and wherein a left metric defining a length of the left planar FOV is numerically equal to a right metric defining a length of the right planar FOV.

For purposes of summarizing the disclosure, certain aspects, advantages, and novel features are discussed herein. It is to be understood that not necessarily all such aspects, advantages, or features will be embodied in any particular embodiment of the disclosure, and an artisan would recognize from the disclosure herein a myriad of combinations of such aspects, advantages, or features.

The embodiments will be more fully understood from the following detailed description thereof, taken together with the drawings.

### DESCRIPTION OF THE DRAWINGS

Non-limiting features of some embodiments are set forth with particularity in the claims that follow. The following drawings are for illustrative purposes only and show non-limiting embodiments. Features from different figures may be combined in several embodiments.

FIG. 1 is a schematic pictorial illustration showing an example head-mounted unit with digital loupe capabilities in use in a surgical procedure, in accordance with an embodiment of the disclosure;

FIG. 2 is a schematic pictorial illustration showing details of the head-mounted unit of FIG. 1;

FIG. 3 is a flow chart that schematically illustrates a method for generating magnified images for display;

FIG. 4 is a schematic pictorial illustration showing a magnified image presented in a portion of a display, in accordance with an embodiment of the disclosure;

FIG. 5 is a schematic figure illustrating an example head-mounted unit, according to an embodiment of the disclosure;

FIG. 6 is a flow chart that schematically illustrates a method for calibrating a stereoscopic digital loupe, in accordance with an embodiment of the disclosure;

FIGS. 7A, 7B, and 7C are schematic figures illustrating the operation of cameras in a head-mounted unit, in accordance with an embodiment of the disclosure;

FIG. 8 is a flow chart that schematically illustrates a method for generating a stereoscopic digital loupe display, in accordance with an embodiment of the disclosure;

FIG. 9A is another schematic pictorial illustration showing a magnified image presented in a portion of a display, in accordance with an embodiment of the disclosure;

FIG. 9B is a schematic pictorial illustration showing a stereoscopic image generated by a head-mounted unit in accordance with an embodiment of the disclosure;

FIG. 10 is a flow chart that schematically illustrates a method for obscuring reality when a digital loupe is activated;

FIG. 11 is a schematic pictorial illustration of an embodiment of a display incorporating a neutral density filter;

FIG. 12 illustrates several embodiments of neutral density filter assemblies that can be coupled to a head-mounted unit;

FIG. 13 is a chart illustrating example light transmission for various neutral density filters;

FIG. 14 is a schematic figure illustrating the operation of cameras in a head-mounted unit, in accordance with an embodiment of the disclosure; and

FIG. 15 is a flow chart that schematically illustrates a method for initializing and using cameras in a toe-in arrangement, in accordance with an embodiment of the disclosure.

### DETAILED DESCRIPTION

Embodiments of the present disclosure that are described herein provide a digital stereoscopic display and digital loupes utilizing the digital stereoscopic display, in which the digital loupes include a head-mounted digital camera or a video camera and electronic display or two near-eye displays including a digital loupe. In accordance with several embodiments, the digital stereoscopic display and digital loupes described herein advantageously offer a simple off-axis (or parallel) visible light camera setup utilizing a digital convergence and a utilization of a distance or tracking camera of a head-mounted display (HMD) device to provide one or more of the following benefits: (i) less consumption of resources, (ii) robust automatic focusing, (iii) robust stereoscopic tuning, (iv) reduced size and weight, by comparison with traditional optical loupes, (v) reduced interference of reality seen through a see-through display with magnified images, and/or (vi) improved versatility and case of use in adjusting the display to accommodate, for example, the user's pupil spacing, region of interest, and/or desired magnification.

In addition, embodiments disclosed herein provide a stereoscopic display of a scene, and specifically, stereoscopic magnification of a scene, to a user (e.g., wearer of the HMD device) without or with minimal visual discomfort and/or visual fatigue. In accordance with several embodiments, such a display may be especially advantageous when displaying images of a scene which is relatively proximate, or close, to the user (e.g., distance around 0.5 meter or up to one meter from the user or wearer), such as when displaying images of a body site to a surgeon or other healthcare professional while he or she is operating on a patient or performing an interventional procedure, therapy or diagnosis. In accordance with several embodiments, digital loupes can be integrated advantageously with head-mounted displays (e.g., over-the-head mounted device displays or eyewear displays), such as displays that are used, for example, in systems for image-guided surgery, computer-assisted navigation, and stereotactic surgery. In accordance with further embodiments, a proper stereoscopic view may be achieved without the need to discard information thus providing maximal information to the viewer. In accordance with some embodiments, a proper stereoscopic view is provided while better utilizing or saving in computer resources.

The surgery may comprise open surgery or minimally invasive surgery (e.g., keyhole surgery, endoscopic surgery, or catheter-based interventional procedures that do not require large incisions, such as incisions that are not self-sealing or self-healing without staples, adhesive strips, or other fasteners or adhesive elements).

Alternatively, stereoscopic display and digital loupes of this sort can be used in other medical applications to provide the practitioner with a stereoscopic and optionally magnified view for purposes of treatment and/or diagnosis.

In some implementations, the digital loupes provide a stereoscopic display that is convergence-based. A distance from the digital loupes to a region of interest may be determined, for example by using an optical tracking device or system (such as an infrared camera) or by using image analysis or can be set manually by a user or operator. In some implementations, the digital loupes provide stereoscopic viewing during a surgical or other interventional procedure. In some implementations, the digital loupes facilitate adjustment of magnification, focus, angle or view, or other display setting adjustment based on both digital camera images (e.g., obtained from one or more RGB cameras) and images received from a tracking device (e.g., an infrared camera or sensor). In some implementations, a single device may be capable of color video and tracking (e.g., an RGB-IR device that includes one or more RGB cameras and one or more infrared cameras or sensors). The tracking device may be used to determine distance or depth measurements from the digital loupes to the region of interest.

In the disclosed embodiments, an imaging apparatus comprises a head-mounted unit (e.g., over-the-head unit or eyewear unit, such as glasses, goggles, spectacles, monocle, a visor, a headset, a helmet, head up display, any other suitable type of displaying device mounted on or worn by any portion of a user or wearer's head, including but not limited to the face, crown, forehead, nose and cars, or the like) with a display, e.g., a see-through display and at least one digital camera, (e.g., visible light camera or a video camera), which captures images of a field of view (FOV) that is viewed through the display by a user wearing the head-mounted unit. A processor (integrated within the head-mounted unit or external to the head-mounted unit) processes the captured images so as to generate and present (e.g., output), on the see-through display, a stereoscopic, optionally magnified and optionally augmented image of a region of interest (ROI) (e.g., a portion of or the entire ROI or a current or instantaneous ROI) within the FOV. In accordance with several embodiments, the angular extent or size of the ROI is less than the total angular extent or size of the FOV. One or more algorithms may be executed by one or more processors of, or communicatively coupled to, the near-eye displays or digital loupes for stereoscopic display of the magnified image.

In some embodiments, the head-mounted displays are not used or used together with stand-alone displays, such as monitors, portable devices, tablets, etc. The display may be a hands-free display such that the operator does not need to hold the display. Other embodiments could include a display or a see-through display that is not head-mounted but is mounted to one or more arms, stands, supports, or other mechanical structures such that the display is hands-free and mounted over the ROI (and/or in a position that enables viewing therethrough of at least a portion of the ROI). Other embodiments could also include a display or a see-through display that is mounted to a part of the body other than the head (such as, for example, to an arm, a wrist, a hand, a torso, a waist, a neck, and/or the like).

In some embodiments, the processor generates and presents a magnified stereoscopic image on a display, e.g., a see-through display, so that the user is able to see a magnified 3D-like view of an ROI. The 3D-like view may be formed by generating a three-dimensional effect which adds an illusion of depth to the display of flat or two-dimensional (2D) images, e.g., images captured by the digital camera, e.g., visible light cameras. The 3D-like view may include 2D or 3D images (e.g., pre-operative and/or intraoperative anatomical medical images), virtual trajectories, guides or icons, digital representations of surgical tools, instruments (e.g., implants), operator instructions or alerts, and/or patient information). For this purpose, inter alia, the head-mounted unit (e.g., over-the-head unit or eyewear) may comprise a first and a second digital cameras, disposed as left and right cameras (e.g., video camera). In some embodiments, the left and right cameras are mounted such that once the HMD device is worn by a user, the cameras will be located in a symmetrical manner with respect to the user's (wearer's) nose or the user's head midline. Accordingly, the left and right cameras may be disposed on a plane substantially parallel to a coronal or frontal plane of the user's head and in a symmetrical manner with respect to a longitudinal plane of the head of a user wearing the HMD device. The processor generates the stereoscopic image based on the images captured by both the left and right cameras. For stereoscopic viewing, the display may comprise a first and a second or left and right near-eye displays, which present respective left and right images (e.g., non-magnified or magnified images, augmented on reality or non-augmented) of the ROI in front of the user's left and right eyes, respectively. In several implementations, the processor applies or may cause a shift (e.g., horizontal shift) to be applied to the left and right images (e.g., magnified images) based on the distance from the head-mounted unit (e.g., from the plane on which the cameras are disposed) to the ROI. The processor may estimate this distance by various distance measurement means, as described further hereinbelow. The processor(s) of the HMD 28 may be in communication with one or more input devices, such as a pointing device, a keyboard, a foot pedal, or a mouse, to allow the operator to input data into the system. In some embodiments HMD 28 may include one or more input devices, such as a touch screen or buttons. Alternatively or additionally, users of the system may input instructions to the processor(s) using a gesture-based interface. For this purpose, for example, the depth sensors described herein may sense movements of a hand of the healthcare professional. Different movements of the professional's hand and fingers may be used to invoke specific functions of the one or more displays and of the system.

The disclosed systems, software products and methods for stereoscopic display may generally apply to the display of images, and specifically to the display of magnified and/or augmented images, in which, discrepancy between right and left eye images may have a more prominent effect on the quality of the stereoscopic display and the user's (wearer's) experience, including visual discomfort and visual fatigue. Furthermore, such discrepancies and their shortcomings may be further enhanced when the images are displayed on a near-eye display and in an augmented reality setting. Systems, software products and methods described herein may be described with respect to the display of magnified images and for generating a digital loupe, but may also apply, mutatis mutandis, to the display of non-magnified images.

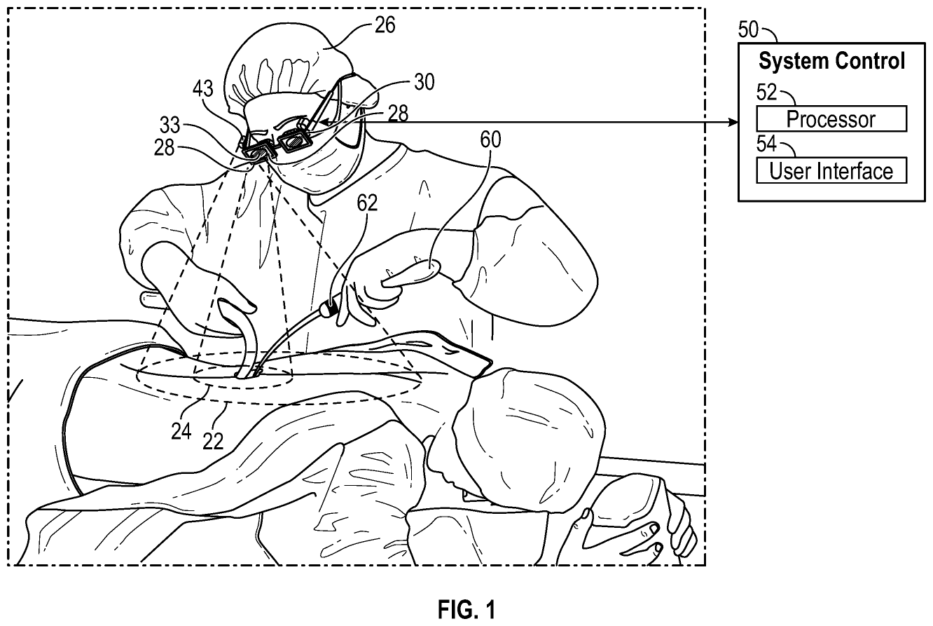

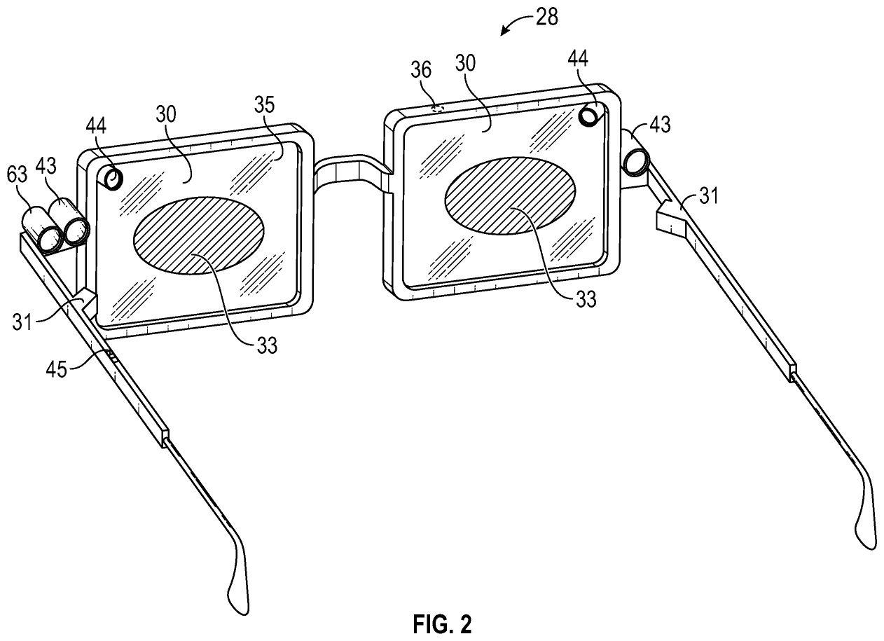

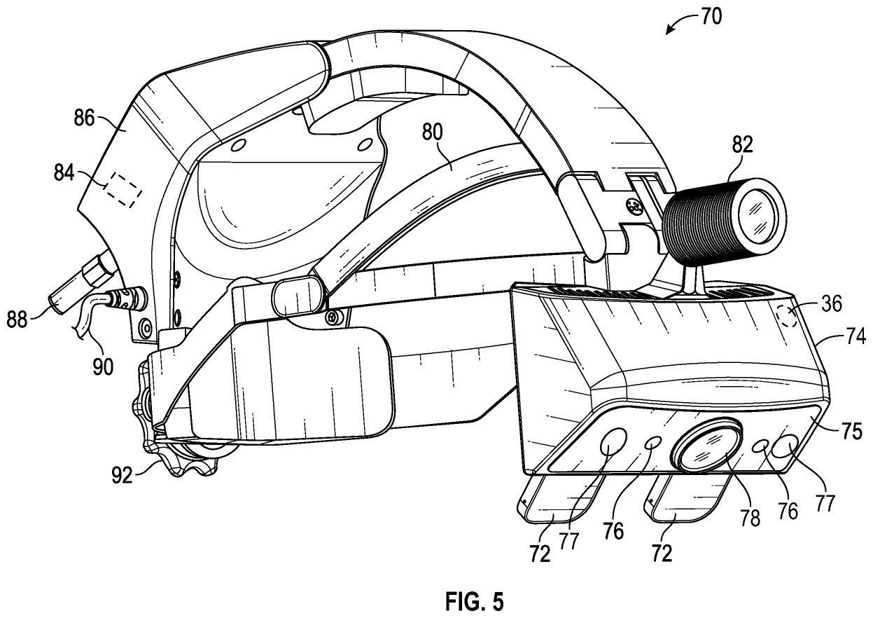

Reference is now made to FIGS. 1 and 2, which schematically illustrate a head-mounted unit 28 with digital loupe capabilities, in accordance with some embodiments of the disclosure. Head-mounted unit 28 may display magnified images of a region of interest (ROI) 24 viewed by a user, such as a healthcare professional 26. FIG. 1, for example, is a pictorial illustration of a surgical scenario in which head-mounted unit 28 may be used, while FIG. 2, for example, is a pictorial illustration showing details of an example of a head-mounted unit 28 in the form of eyewear. In some embodiments, the head-mounted unit 28 can be configured as an over-the-head mounted headset that may be used to provide digital loupe functionality such as is shown in FIG. 5 and described hereinbelow.

In the embodiment illustrated in FIG. 1, head-mounted unit 28 comprises eyewear (e.g., glasses or goggles) that includes one or more see-through displays 30, for example as described in Applicant's U.S. Pat. No. 9,928,629 or in the other patents and applications cited above, whose disclosure is incorporated herein by reference. Displays 30 may include, for example, an optical combiner, a waveguide, and/or a visor. Displays 30 may be controlled by one or more computer processors. The one or more computer processors may include, for example, a computer processor 52 disposed in a central processing system 50 and/or a dedicated computer processor 45 disposed in head-mounted unit 28. The one or more processors may share processing tasks and/or allocate processing tasks between the one or more processors. The displays 30 may be configured (e.g., programmed upon execution of stored program instructions by the one or more computer processors) to display an image (e.g., one or more 2D images or 3D images) to healthcare professional 26, who is wearing the head-mounted unit 28.

In some embodiments, the image is an augmented reality image. In some embodiments the augmented reality image viewable through the one or more see-through displays 30 is a combination of objects visible in the real world with the computer-generated image. In some embodiments, each of the one or more see-through displays 30 comprises a first portion 33 and a second portion 35. In some embodiments, portions 33, 35 may be transparent, semi-transparent opaque or substantially opaque. In some embodiments, the one or more see-through displays 30 display the augmented-reality image. In some embodiments, images are presented on the displays 30 using one or more micro-projectors 31.

In some embodiments, the image is presented on displays 30 such that a magnified image of ROI 24 is projected onto the first portion 33, in alignment with the anatomy of the body of the patient that is visible to healthcare professional 26 through the second portion 35. Alternatively, the magnified image may be presented in any other suitable location on displays 30, for example above the actual ROI 24 or otherwise not aligned with the actual ROI 24. Displays 30 may also be used to present additional or alternative augmented-reality images (e.g., one or more 2D images or 3D images or 3D-like images), such as described in U.S. Pat. No. 9,928,629 or the other patents and applications cited above.

To capture images of ROI 24, head-mounted unit 28 includes one or more cameras 43. In some embodiments, one or more cameras 43 are located in proximity to the eyes of healthcare professional 26, above the eyes and/or in alignment with the eyes' location (e.g., according to the user's measured inter-pupillary distance (IPD)). Camera(s) 43 are located alongside the eyes in FIG. 2; but alternatively, camera(s) 43 may be mounted elsewhere on unit 28, for example above the eyes or below the eyes. According to some aspects, only one camera 43 may be used, e.g., mounted above the eyes near a center of the head-mounted unit 28 or at another location. Camera(s) 43 may comprise any suitable type of digital camera, such as miniature color video cameras (e.g., RGB cameras or RGB-IR cameras), including an image sensor (e.g., CMOS sensor) and objective optics (and optionally a color array filter). In accordance with several embodiments, camera(s) 43 capture respective images of a field of view (FOV) 22, which may be considerably wider in angular extent than ROI 24, and may have higher resolution than is required by displays 30. With continued reference to FIG. 2, some embodiments of head-mounted units 28 may also include an ambient light sensor 36, configured to detect, for example, a brightness of the ambient environment in which the head-mounted unit 28 is used. Some embodiments may also or alternatively be configured to detect or estimate an ambient light level using the output of the camera(s) 43 and/or other sensors capable of detecting an ambient light level.

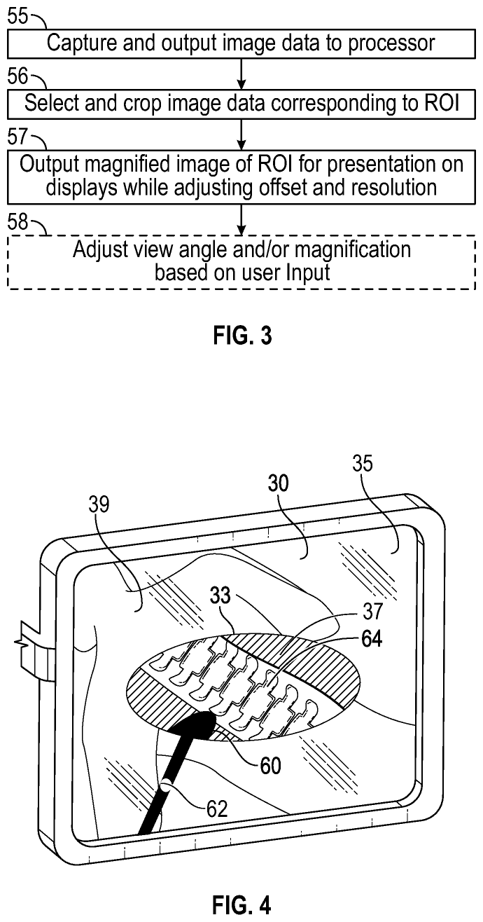

FIG. 3 is a flow chart that schematically illustrates an example method for generating magnified images for presentation on displays 30. To generate the magnified images that are presented on displays 30, camera(s) 43 (at an image capture step 55) capture and output image data with respect to FOV 22 to processor 45 and/or processor 52. At a data selection step 56, the processor 45, 52 may receive, select, read and/or crop (via software and/or via sensor hardware) the portion of the data or the image data corresponding to the ROI, e.g., ROI 24. According to some aspects, the processor 45, 52 may select, read and/or crop a central portion of the image. According to some aspects, the processor 45, 52 may read, receive or process only information received from a predefined portion or region or from a determined (e.g., iteratively determined) image region of the image sensor. A predefined such portion or only initially predefined such portion or region may be, for example, a predefined central portion of the image sensor or light sensor (e.g., CMOS sensor or charge-coupled device image sensor) of the camera(s) 43. Optionally, the processor 45, 52 may then crop or process a further portion or a sub-portion of this predefined portion (e.g., further reduce the information received from the image sensor or light sensor of the camera(s) 43), as will be detailed hereinbelow.

In accordance with several embodiments, to improve the stereoscopic view and prevent eye discomfort, the processor 45, 52 may display to the user only overlapping portion of the images captured by the left and right cameras 43. In addition, the processor 45, 52 may discard non-overlapping portions of the images captured by the left and/or right cameras 43. Non-overlapping image portions may be image portions which show portions of the FOV 22 (e.g., with respect to a plane of interest) not captured by both right and left cameras 43, but only by one of the cameras 43. Thus, in accordance with several embodiments, only an overlapping portion of the right and left images corresponding to a portion of the FOV 22 (e.g., overlapping portions of a plane of interest) captured by both right and left cameras 43 will be displayed to the user (e.g., wearer) to generate a proper stereoscopic view. In accordance with some embodiments, a display of the overlapping portions may be provided by shifting the left and right image on the left and right display, respectively, such that the center of the overlapping portion of each image would be displayed in the center of each respective display.

In accordance with some other embodiments, the selection of image data may be performed on the image sensor, e.g., via the image sensors, instead or in addition to selection performed on the received image data.

In accordance with some embodiments, the processor 45, 52 may select or determine the sensor image region from which data is received and based on which the image is generated. In some embodiments, the sensor image region from which data is received for each camera is determined to be the sensor image region which images only the overlapping portion. Thus, the display of the overlapping portions may be achieved by receiving image date from the left and right sensors, respectively, including only the overlapping portion.

In accordance with some embodiments, to achieve a proper stereoscopic view without losing image information, processor 45, 52 may change the horizontal location of the left image region or of the right image region, or both, without reducing their size (or substantially keeping their size), and such that the images generated from the left and right cameras would be entirely overlapping or substantially overlapping, showing the same portion of FOV 22 (e.g., of a horizontal plane of FOV 22).

Based on the image information received from cameras 43, the processor 45, 52 (at an image display step 57) generates and outputs a magnified image of the ROI 24 for presentation on displays 30. In some embodiments, the magnified images presented on the left and right displays 30 may be shifted (e.g., horizontally shifted) to give healthcare professional 26 a better stereoscopic view. In some embodiments, processor 45 and/or 52 may be configured to adjust the resolution of the magnified images of the ROI 24 to match the available resolution of displays 30, so that the eyes see an image that is clear and free of artifacts. In some embodiments, magnification would be achieved by down sampling. According to some aspects, healthcare professional 26 may adjust the FOV 22 (which includes ROI 24) by altering a view angle (e.g., vertical view angle to accommodate the specific user's height and/or head posture), and/or the magnification of the image that is presented on displays 30, for example by means of a user interface 54 of processing system 50 (optional user adjustment step 58). User interface 54 may comprise hardware elements, such as knobs, buttons, touchpad, touchscreen, mouse, foot pedal and/or a joystick, as well as software-based on-screen controls (e.g., touchscreen graphical user interface elements and/or voice controls (e.g., voice-activated controls using a speech processing hardware and/or software module). In some embodiments, user interface 54 or a portion of it may be implemented in head-mounted unit 28. Additionally, or alternatively, the vertical view angle of the head-up display unit may be manually adjusted by the user (e.g., via a mechanical tilt mechanism).

The head-mounted unit 28 may be calibrated according to the specific types of users or to the specific user (e.g., to accommodate the distance between the user's pupils (interpupillary distance) or to ranges of such a distance) and/or his or her preferences (e.g., visualization preferences). For this purpose, in some embodiments, the location of the portion of the displays 30 on which images are presented (e.g., displays portion 33 of FIG. 2), or the setup of camera(s) 43, or other features of head-mounted unit 28 may be produced and/or adjusted according to different ranges of measurements of potential users or may be custom-made, according to measurements provided by the user, such as healthcare professional 26. Alternatively or additionally, the user may manually adjust or fine-tune some or all of these features to fit his or her specific measurements or preferences.

In some embodiments, the head-mounted unit is configured to display and magnify an image, assuming the user's gaze would be typically straightforward. In some embodiments, the angular size or extent of the ROI and/or its location is determined, assuming the user's gaze would be typically straightforward with respect to the user's head posture. In some embodiments, the user's pupils' location, gaze and/or line of sight may be tracked. For example, one or more eye trackers 44 may be integrated into head-mounted unit 28, as shown in FIG. 2, for real-time adjustment and possibly for purposes of calibration. Eye trackers 44 comprise miniature video cameras, possibly integrated with a dedicated infrared light source, which capture images of the eyes of the user (e.g., wearer) of head-mounted unit 28. Processor 45 and/or 52 or a dedicated processor in eye trackers 44 processes the images of the eyes to identify the locations of the user's pupils. Additionally or alternatively, eye trackers 44 may detect the direction of the user's gaze using the pupil locations and/or by sensing the angle of reflection of light from the user's corneas.

In some embodiments, processor 45 and/or processor 52 uses the information provided by eye trackers 44 with regard to the pupil locations in generating an image or a magnified image for presentation on displays 30. For example, the processor 45, 52 may dynamically determine a crop region or an image region on each sensor of each camera to match the user's gaze direction. The location of a sensor image region may be changed, e.g., horizontally changed, in response to a user's gaze current direction. The detection of the user's gaze direction may be used for determining a current ROI to be imaged. According to some embodiments, the image generated based on the part or region of the sensor corresponding to the shifted or relocated crop or image region or ROI 24 may be magnified and output for display. By “shift” when referring to a shift performed on an image sensor, e.g., shift of a pixel, an array, a set or subset of pixels (e.g., an image region of the image sensor including a set, subset or an array of pixels), the shift may be performed by shifting one or more bounding pixels of a region, set or array of pixels while each one or more bounding pixels may be shifted by a different value thus changing the size of the region, set or array of pixels, or the shift may be applied to the region, set or array as a whole, thus keeping the size of the region or array.

For improved stereoscopic display, the processor 45, 52 may be programmed to calculate and apply the shift (e.g., horizontal shift) to the left and right images presented on displays 30 or be programmed to calculate and apply the relocation of a left image region on the left image sensor, or of a right image region on the right image sensor, or both, to reduce or substantially avoid parallax between the user's eyes at the actual or determined distance from head-mounted unit 28 to ROI 24. In other words, the shift (e.g., horizontal shift) of the left and right images on the left and right display 30, respectively, or the change of location (e.g., horizontal location) of at least one image region on the respective image sensor depends on the distance and geometry of the cameras (e.g., relative to a plane of interest of ROI 24). The distance to the ROI 24 can be estimated by the processor 45, 52 in a number of different ways, as will be described further below:

In some embodiments, the processor 45, 52 may measure the disparity between the images of ROI 24 captured by left and right cameras 43 based on image analysis and may compute the distance to the ROI 24 based on the measured disparity and the known baseline separation between the cameras 43. In some embodiments, the processor 45, 52 may compute the distance to the ROI 24 based on the focus of the left and/or right cameras 43. For example, once the left and/or right camera 43 is focused on the ROI 24, standard “depth from focus” techniques known to those skilled in the art may be used to determine or estimate the distance to the ROI 24.

In some embodiments, based on signals provided by the one or more eye trackers 44, the processor 45, 52 may compare the gaze angles of the user's left and right eyes to find the distance at which the eyes converge on ROI 24.

In some embodiments, head-mounted unit 28 may comprise a distance sensor or tracking device 63, which measures the distance from the head-mounted unit 28 to ROI 24. The distance sensor or tracking device 63 may comprise an infrared sensor, an image-capturing tracking camera, an optical tracker, or other tracking/imaging device for determining location, orientation, and/or distance. The distance sensor or tracking device 63 may also include a light source to illuminate the ROI 24 such that light reflects from an optical marker, e.g., on a patient or tool, toward the distance sensor or tracking device 63. In some embodiments, an image-capturing device of the tracking device 63 comprises a monochrome camera with a filter that passes only light in the wavelength band of the light source. In one implementation, the light source may be an infrared light source, and the camera may include a corresponding infrared filter. In other implementations, the light source may comprise any other suitable type of one or more light sources, configured to direct any suitable wavelength or band of wavelengths of light, and mounted on head-mounted unit 28 or elsewhere in the operating room.

In some embodiments, distance sensor or tracking device 63 may comprise a depth sensor configured to illuminate the FOV 22 or the ROI 24 with a pattern of structured light (e.g., via a structured light projector) and capture and process or analyze an image of the pattern on the FOV 22 in order to measure the distance. In this case, distance sensor or tracking device 63 may comprise a monochromatic pattern projector such as of a visible light color and a visible light camera. In some embodiments, the depth sensor may be used for focus and stereo rectification. A professional skilled in the art would know how to employ other depth sensing methods and devices for measuring the distance, such as described, for example, in PCT International Application Publication No. WO2023/021448, titled “Augmented-Reality Surgical System Using Depth Sensing,” the disclosure of which is herein incorporated by reference.

In some embodiments, the distance may be determined by detecting and tracking image features of the ROI and based on triangulation. Image features may be detected in a left camera image and a right camera image based on, for example, ORB method (E. Rublee et al., “ORB: an efficient alternative to SIFT or Surf”, Conference Paper in Proceedings/IEEE International Conference on Computer Vision. IEEE International Conference on Computer Vision⋅November 2011). The detected features may be then tracked (e.g., based on Lucas-Kanade method). Triangulation (2D feature to 3D point) may be performed based on the calibration parameters of the left and right cameras forming a 3D point cloud. Distance may be then estimated based on the generated point cloud, e.g., based on median of distances.

In some embodiments, the processor 45, 52 may measure the distance from head-mounted unit 28 to an element in or adjacent to the ROI, e.g., ROI 24 while, utilizing, for example, a tracking camera of the head-mounted unit 28. In such embodiments, distance sensor 63 may be the tracking camera. With reference to FIG. 1, tool 60 may be manipulated by healthcare professional 26 within the ROI 24 during the surgical or other interventional or diagnostic medical procedure. The tool 60 may be, for example, a tool used for inserting a surgical implant, such as a pedicle screw, stent, cage, or interbody device, into the body (e.g., bone, vessel, body lumen, tissue) of a patient. For this purpose, for example, the tool 60 may comprise an optical marker 62 (example shown in FIG. 1), having a known pattern detectable by distance sensor or tracking device 63. An optical patient marker (not shown in the figures), which may be fixedly attached to the patient (e.g., to the patient's skin or a portion of the patient's anatomy, such as a portion of the patient's spine) may also be detectable by distance sensor or tracking device 63. The processor 45, 52 may process images of marker 62 in order to determine (e.g., measure) the location and orientation of tool 60, a tip of tool 60, a tip of an implant attached to tool 60 or an intersection point between the trajectory of the tool and the patient's anatomy with respect to the head-mounted unit 28 or wearer of the head-mounted unit 28, and thus to determine (e.g., estimate or calculate) the distance between the ROI, e.g., ROI 24, and the user (e.g., wearer of the head-mounted unit 28). The distance may be determined by the distance sensor 63 (such as an infrared camera, optical sensor, or other tracking device). In some embodiments, the processor 45, 52 may process images of the patient marker or of the patient marker and tool marker in order to determine the relative location and orientation of the patient marker or of patient marker and tool marker with respect to the head mounted unit 28 or the user, and thus to determine the distance between the user and the ROI such as ROI 24. Such head mounted display systems are described, for example, in the above-referenced U.S. Pat. Nos. 9,928,629, 10,835,296, 10,939,977, PCT International Publication WO 2019/211741, U.S. Patent Application Publication 2020/0163723, and PCT International Publication WO 2022/053923, which were previously incorporated by reference. Markers are described, for example, in U.S. Pat. No. 10,939,977, the content of which is also hereby incorporated herein by reference.

The processor 45, 52 may compute the distance to ROI 24 based on any one of the above methods, or a combination of such methods or other methods that are known in the art. Alternatively or additionally, healthcare professional 26 may adjust the shift (e.g., horizontal shift) or location of the overlapping portions of the captured images manually.

In accordance with several embodiments, utilizing optical tracking of the head mounted unit 28 as disclosed above to dynamically provide the distance to the ROI 24 allows for a less resource consuming and more robust distance measurement, for example with respect to distance measurement based on image analysis.

In accordance with several embodiments, a plane of interest of the ROI (e.g., ROI 24) substantially parallel to a frontal plane of the user's head, may be defined with respect to each of the methods for distance measurement described hereinabove or any other method for distance measurement which may be employed by a person skilled in the art. The plane is defined such that the measured or estimated distance is between the plane of interest and the head mounted unit, e.g., head-mounted unit 28 or 70. For example, when distance is measured via an element in or adjacent to the ROI such as the tool marker, the patient marker or a combination of both, the plane of interest may be defined with respect to the tool, the patient or both, respectively. The plane of interest may be then defined, for example, as the plane parallel to the frontal plane and intersecting the tip of the tool or an anatomical feature of the patient.

The distance sensor or tracking device 63 may comprise a light source and a camera (e.g., camera 43 and/or an IR camera). The light source may be adapted to simply illuminate the ROI 24 (e.g., a projector, a flashlight or headlight). The light source may alternatively include a structured light projector to project a pattern of structured light onto the ROI 24 that is viewed through displays 30 by a user, such as healthcare professional 26, who is wearing the head-mounted unit 28. The camera (e.g., camera(s) 43 and/or infrared camera) may be configured to capture an image of the pattern on the ROI 24 and output the resulting distance or depth data to processor 52 and/or processor 45. The distance or depth data may comprise, for example, either raw image data or disparity values indicating the distortion of the pattern due to the varying depth of the ROI 24.

Alternatively, distance sensor or tracking device 63 may apply other depth mapping technologies in generating the depth data. For example, the light source may output pulsed or time-modulated light, and the camera (e.g., camera 43) may be modified or replaced by a time-sensitive detector or detector array to measure the time of flight of the light to and from points in the ROI 24. Distance sensing and measurements may be performed without use of a marker, The distance sensor may include a laser-based time-of-flight sensors. These and all other suitable alternative depth mapping technologies are considered to be within the scope of the present disclosure.

FIG. 4 is a schematic pictorial illustration showing a magnified image 37 presented in portion 33 of display 30, with reality 39 visible through portion 35 of display 30, in accordance with an embodiment of the disclosure. The magnified image 37 shows an incision 62 made by healthcare professional 26 in a back 60 of a patient, with an augmented-reality overlay 64 showing at least a portion of the patient's vertebrae (e.g., cervical vertebrae, thoracic vertebrae, lumbar vertebrae, and/or sacral vertebrae) and/or sacroiliac joints, in registration with the magnified image. For example, overlay 64 may include a 2D image or a 3D image or model of the region of interest (ROI 24) magnified to the same proportion as the magnified image displayed in portion 33 (e.g., a video image). The overlay 64 may be then augmented or integrated, for example, on the digitally magnified image (e.g., video image) and in alignment with the magnified image. Overlay 64 may be based, for example, on a medical image (e.g., obtained via computed tomography (CT), X-ray, or magnetic resonance imaging (MRI) systems) acquired prior to and/or during the surgical procedure or other interventional or diagnostic procedure (e.g., open surgical procedure or minimally invasive procedure involving self-sealing incisions, such as catheter-based intervention or laparoscopic or keyhole surgery). The overlay image may be aligned or otherwise integrated with the magnified image by using image analysis (e.g., by feature-based image registration techniques). In some embodiments, such alignment and/or registration may be achieved by aligning the overlay image with the underlying anatomical structure of the patient, while assuming the magnified image is substantially aligned with the patient anatomy. Alignment and/or registration of such an overlay with the underlying anatomical structure of a patient is described, for example, in the above-mentioned U.S. Pat. No. 9,928,629, which was previously incorporated by reference, and as well as in US Patent Application Publication 2021/0161614, the entire contents of which are incorporated herein by reference. In some embodiments, the magnified image may include only augmented-reality overlay 64. In some embodiments, one or more eye trackers (e.g., eye trackers 44) may be employed which may allow a more accurate alignment of the magnified image with the underlying patient anatomy. The eye tracker may allow capturing the ROI and may also allow a display of the image on the near-eye display in alignment with the user's line of sight and the ROI in a more accurate manner when the user is not looking straightforward.

In some procedures, such as discectomy or spinal fusion, the surgeon needs to identify the patient bone structure for purposes of localization and navigation to a site of interest. The surgeon may then remove tissue and muscles to reach or expose the bone, at least to some extent. This preliminary process of “cleaning” the bone may require time and effort. The site of interest may be then magnified, for example using digital magnification, to facilitate the identification of the patient anatomy and the performance of the procedure. It may be still challenging, however, to identify the patient anatomy and navigate during the procedure due to tissue and muscles left in the site of interest.

To address this difficulty, a 3D spine model (generated from an intraoperative or preoperative CT scan or other medical image scan) can be presented with (e.g., superimposed on or integrated into) the magnified image of the patient anatomy, as shown in FIG. 4. The alignment of this image with the patient's anatomy can be achieved by means of a registration process, which utilizes a registration marker mounted on an anchoring implement, for example a marker attached to a clamp or a pin. Registration markers of this sort are shown and described, for example, in the above-mentioned U.S. Pat. No. 9,928,629, in US Patent Application Publication 2021/0161614, which were previously incorporated by reference, as well as in US Patent Application Publication 2022/0142730, the entire contents of which are incorporated herein by reference. For this purpose, an intraoperative CT scan or other medical image scan of the ROI 24 is performed, including the registration marker. An image of the ROI 24 and of a patient marker attached (e.g., fixedly attached) to the patient anatomy or skin and serving as a fiducial for the ROI 24 is captured, for example using a tracking camera such as distance sensor or tracking device 63 of head-mounted unit 28 or camera 78 of head-mounted unit 70. The relative location and orientation of the registration marker and the patient marker are predefined or determined, e.g., via the tracking device. The CT or other medical image and tracking camera image(s) may then be registered based on the registration marker and/or the patient marker. The anatomical image model (e.g., CT model) may be then displayed in a magnified manner (e.g., corresponding to the magnification of the patient anatomy image) and aligned with the image and/or with reality.

The anatomical image model (e.g., CT model) may be presented on display(s) 30, for example, in a transparent manner, in a semi-transparent manner, in an opaque manner, or in a substantially opaque manner and/or as an outline of the bone structure (e.g., by segmenting the anatomical image model). Thus, in accordance with several embodiments, the surgeon or healthcare professional 26 will advantageously be able to “see” the bone structure which lies beneath tissue shown in the image (e.g., video image) and/or “see” it in a clearer manner. This will facilitate localization and navigation (for example of tool 60) in the patient's anatomy.

Furthermore, using such a view may shorten the “cleaning” process or even render it unnecessary.

Other images may be included (e.g., augmented on or integrated with) the magnified image, such as a planning indication (e.g., planning of a bone-cut or insertion of an implant, such as a bone screw or cage).

The presentation of such information in an augmented manner on the image may be controlled by the user (e.g., on or off or presentation adjustment via the user interface 54).

Additional examples of procedures in which the above may be utilized include vertebroplasty, vertebral fusion procedures, removal of bone tumors, treating burst fractures, or when bone fracturing is required to handle a medical condition (such as scoliosis) or to access a site of interest. Other examples may include arthroscopic procedures (including joint replacement, such as hip replacement, knee replacement, shoulder joint replacement or ankle joint replacement; reconstructive surgery (e.g., hip surgery, knee surgery, ankle surgery, foot surgery); joint fusion surgery; laminectomy; osteotomy; neurologic surgery (e.g., brain surgery, spinal cord surgery, peripheral nerve procedures); ocular surgery; urologic surgery; cardiovascular surgery (e.g., heart surgery, vascular intervention); dental surgery; oncology procedures; biopsies; organ transplants; or other medical procedures.

FIG. 5 is a schematic pictorial illustration showing details of a head-mounted display (HMD) unit 70, according to another embodiment of the disclosure. HMD unit 70 may be worn by healthcare professional 26, and may be used in place of head-mounted unit 28 (FIG. 1). HMD unit 70 comprises an optics housing 74 which incorporates a camera 78, e.g., an infrared camera. In some embodiments, the housing 74 comprises an infrared-transparent window 75, and within the housing, e.g., behind the window, may be mounted one or more, for example two, infrared projectors 76. Additionally or alternatively, housing 74 may contain one or more color video cameras 77, as in head-mounted unit 28, and may also contain eye trackers, such as eye trackers 44. In some embodiments, the head-mounted display unit 70 may also include ambient light sensor 36, as in head-mounted unit 28 discussed above.

In some embodiments, mounted on housing 74 are a pair of augmented reality displays 72, which allow the healthcare professional 26 to view entities, such as part or all of patient 24, through the displays 72, and which are also configured to present to healthcare professional 26 images or any other information. In some embodiments, displays 72 may also present stereoscopic images of ROI 24 (e.g., video images) and particularly magnification of such images of ROI 24 (FIG. 1), as described herein.

In some embodiments, HMD unit 70 includes a processor 84, mounted in a processor housing 86, which operates elements of the HMD unit. In some embodiments, an antenna 88, may be used for communication, for example with processor 52 (FIG. 1).

In some embodiments, a flashlight 82 may be mounted on the front of HMD unit 70. In some embodiments, the flashlight may project visible light onto objects so that the professional is able to clearly see the objects through displays 72. In some embodiments, elements of the HMD unit 70 are powered by a battery (not shown in the figure), which supplies power to the elements via a battery cable input 90.

In some embodiments, the HMD unit 70 is held in place on the head of the healthcare professional 26 by a head strap 80, and the healthcare professional 26 may adjust the head strap by an adjustment knob 92.

Elements shown and described with respect to HMD unit 70, such as antenna 88 and flashlight 82, may be also included, mutatis mutandis, in HMD unit 28, and vice versa.

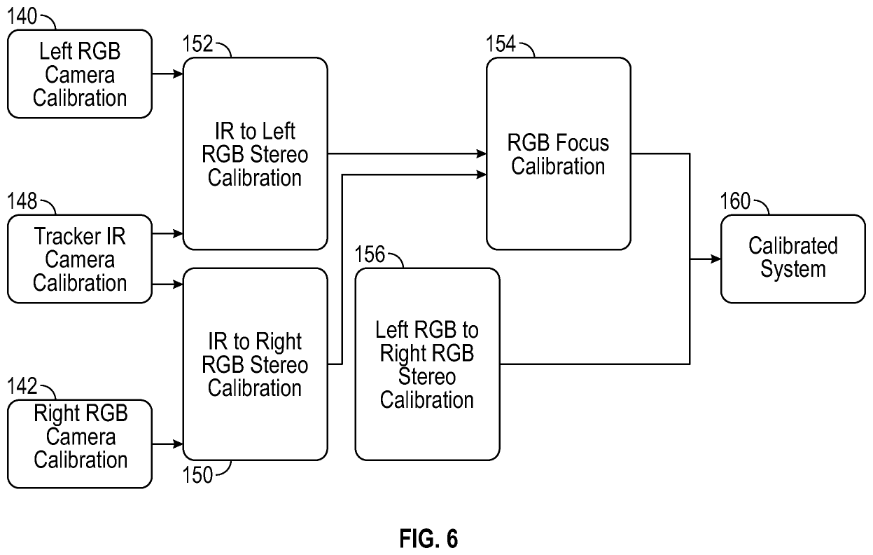

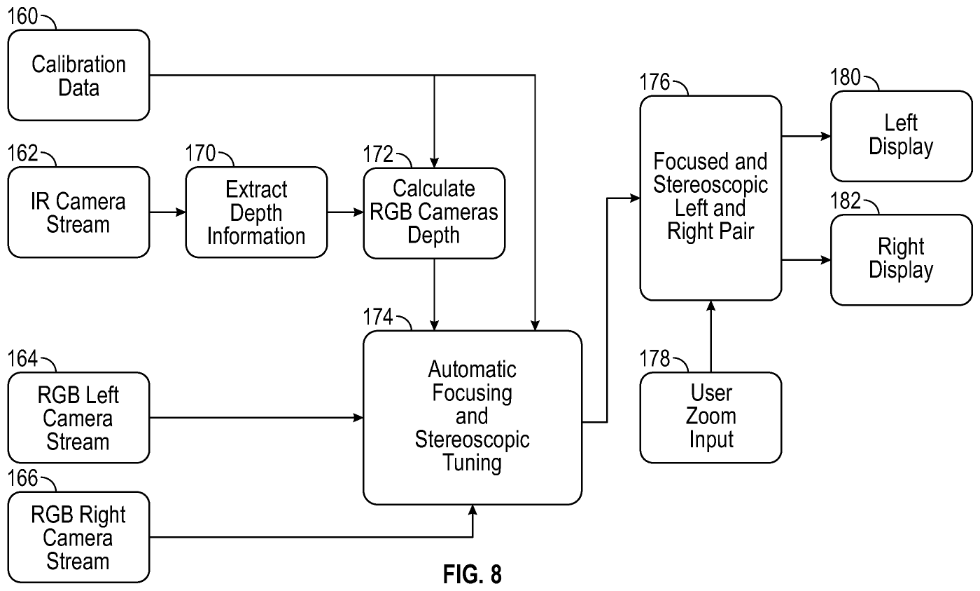

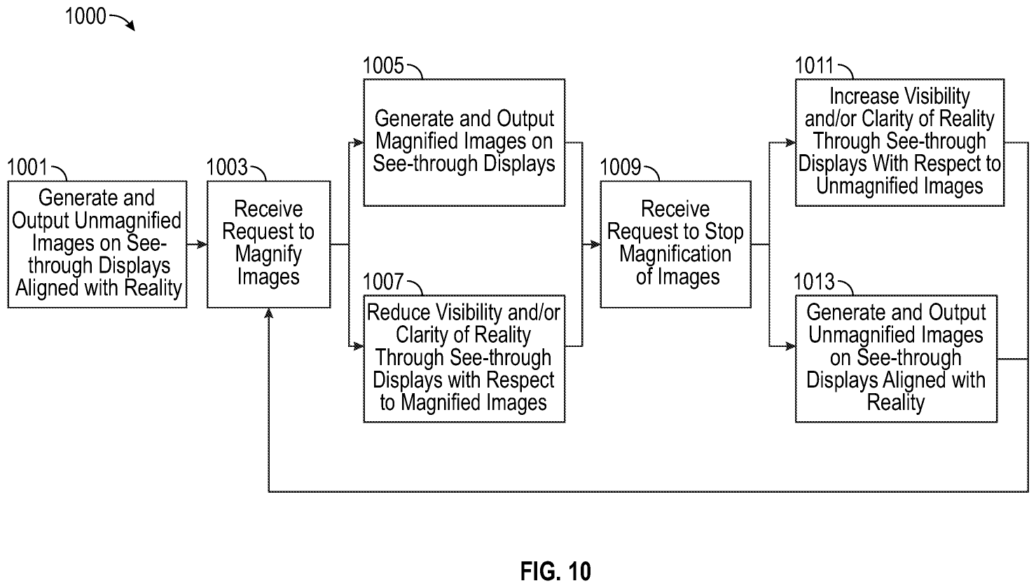

FIG. 6 is a flow chart that schematically illustrates a method for calibrating a stereoscopic digital loupe, in accordance with an embodiment of the disclosure. FIG. 6 specifically relates to a digital loupe using RGB cameras and an IR camera as a tracking and distance measurement device. However, the method of FIG. 6 may be applied, mutatis mutandis, to other configurations. For the sake of clarity and concreteness, this method, as well as the methods of FIGS. 8 and 10, are described herein with reference to the components of head-mounted unit 28 (FIGS. 1 and 2). The principles of these methods, however, may similarly be applied to other stereoscopic digital loupes, such as a loupe implemented by HMD unit 70.

In general, in the context of the present description, when a computer processor is described as performing certain steps, these steps may be performed by one or more external computer processors (e.g., processor 52) and/or one or more computer processors (e.g., processor 45, 84) that is integrated within the HMD unit 28, 70. The processor or processors carry out the described functionality under the control of suitable software, which may be downloaded to the system in electronic form, for example over a network, and/or stored on tangible, non-transitory computer-readable media, such as electronic, magnetic, or optical memory.

In accordance with several embodiments, in generating and presenting magnified stereoscopic images, it is important that the digital cameras (e.g., RGB cameras) be properly calibrated and registered with one another and with the tracking device, in case such is used. The calibration may include both one or more RGB or color video cameras and a tracking device, such as an infrared camera or sensor (e.g., distance sensor 63). In some embodiments, right and left cameras 43 (e.g., color video cameras, such as RGB cameras) and an infrared tracking camera (e.g., an infrared tracking camera in distance sensor or tracking device 63) are calibrated by one or more processors (such as processor 45, 52), at camera calibration steps 140, 142, and 148. These steps may be carried out, for example, by capturing images of a test pattern using each of the cameras and processing the images to locate the respective pixels and their corresponding 3D locations in the captured scene. If appropriate, the camera calibration may also include estimation and correction of distortion in each of the cameras. In some implementations, at least one of the right and left cameras and infrared tracking camera comprises an RGB-IR camera that includes both color video and infrared sensing or imaging capabilities in a single device.

After the individual cameras have been calibrated, the processor 45, 52 or another processor may be used to register, by rigid transformations, the tracking camera, e.g., infrared camera, with the right camera, e.g., right color video camera and with the left camera, e.g., left color video camera, at right and left camera calibration steps 150 and 152, correspondingly. Such registration may include measuring the distances between the optical centers of each of color video cameras 43 and the infrared camera in distance sensor or tracking device 63, at right and left camera calibration steps 150 and 152. The processor 45, 52 may also measure the respective rotations of the color cameras 43 and the infrared camera of the distance sensor or tracking device 63. These calibration parameters or values serve as inputs for a focus calibration step 154, in which the focusing parameters of cameras 43 are calibrated against the actual distance to a target that is measured by the distance sensor or tracking device 63. A map, mapping possible distance values between the HMD and ROI to corresponding focus values may be then generated. On the basis of this calibration, it may be possible to focus both cameras 43 to the distance of ROI 24 that is indicated by the distance sensor or tracking device 63.

For enhanced accuracy in accordance with several embodiments, right and left cameras 43 (e.g., color video cameras) may also be directly registered at a stereo calibration step 156. The registration may include measurement of the distance between the optical centers of right and left cameras 43 and the relative rotation between the cameras 43, and may also include rectification, for example.

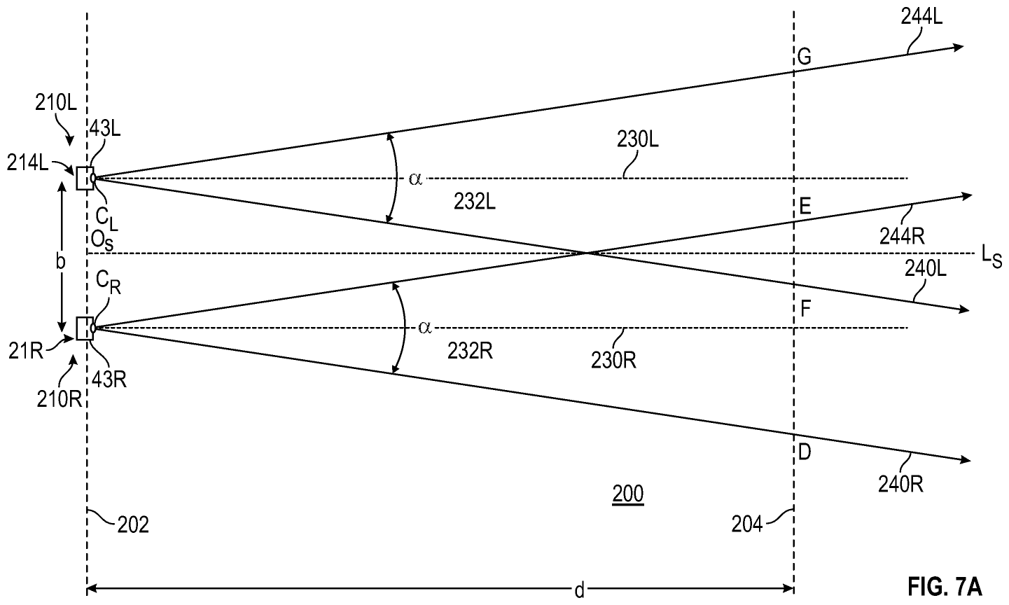

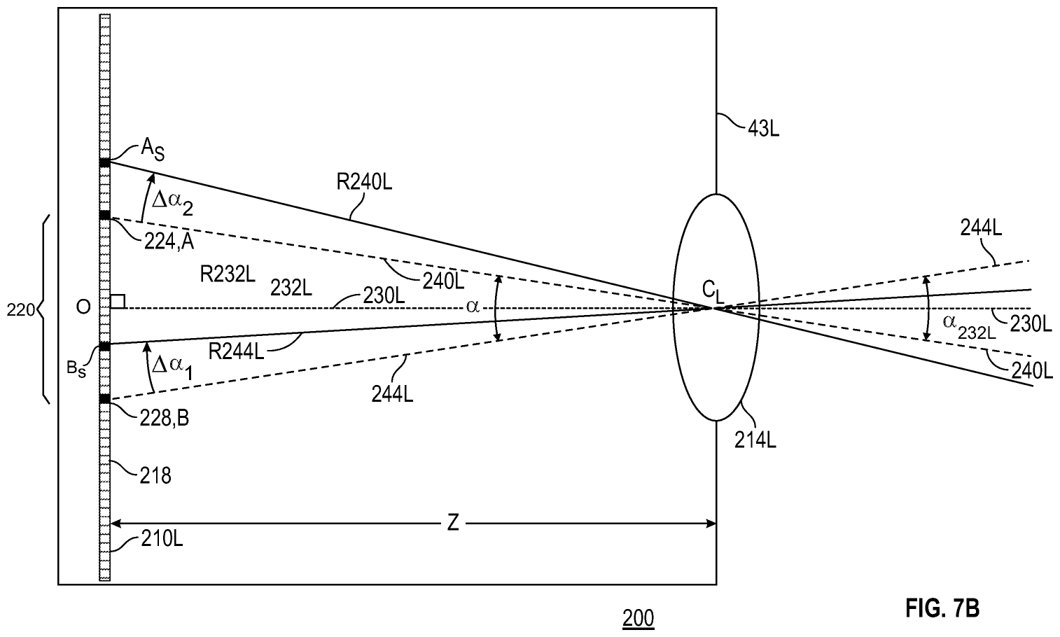

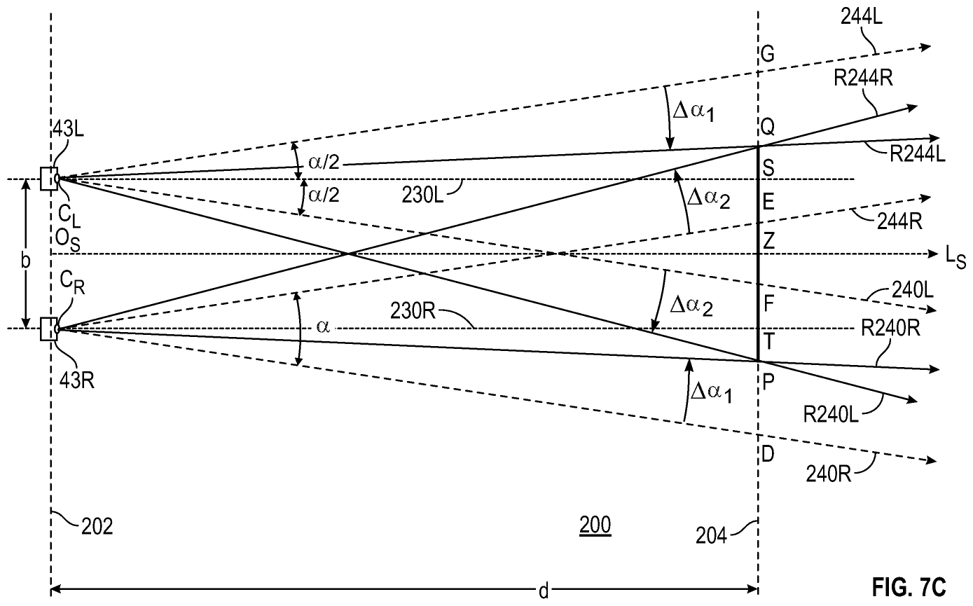

Optionally, and in case image overlapping portions shift is performed, the method may further include an overlapping calibration step. Processor 45, 52 may use these measurements in calculating an appropriate shift (e.g., horizontal shift) to be applied on the display of each of the images captured by the left and right cameras 43 (e.g., color video cameras) in correspondence to the cameras' distance from the ROI 24. Alternatively or additionally, a trigonometric formula may be used. The horizontal shift can be applied in the display of each image and to the center of the overlapping portion of the image such that the center of the overlapping image portion is shifted to the center of the display area (e.g., to the center of portion 33 of display 30 of HMD unit 28). This application may be performed to reduce the parallax between pixels of the right and left eye images to improve the stereoscopic display, as will be further detailed in connection with FIGS. 6 and 7A-7C. The overlapping image portions may vary as a function of the distance from cameras 43 to ROI 24.

Optionally, and in case an on sensor relocation of the image region is performed, the method may further include a sensor shift or relocation calibration step. An empirical mapping of each device may be performed to map the distance between the HMD and the ROI to the respective sensor image region shift or relocation.

At a step 160 the calibration parameters and/or maps determined in the previous steps are stored, e.g., by processor 45, 52 as a calibration system in a memory that is associated with the HMD (e.g., head-mounted unit 28).

The calibration maps may include the mapping between ROI distance and the focusing parameter of cameras 43, as calculated at step 154, optionally a mapping between ROI distance and the horizontal shift of the overlapping left and right camera image portions and/or a mapping between ROI distance and the shift or relocation (e.g., horizontal) of the image region on the sensors of the left and right cameras.

The calibration maps or calibration mapping may include or refer to the generation of a lookup table, one or more formulas, functions, or models or to the estimation of such. Accordingly, processor 45, 52 may obtain or calculate the focus, and/or shift or relocation values while using such one or more lookup tables, formulas, models or a combination of such once distance to the ROI is provided.

According to some embodiments, cameras 43 are mounted on the HMD unit 28 in a parallel or off-axis setup, as shown, for example in FIG. 2 & FIGS. 7A-7C. According to some embodiments, cameras 43 may be mounted on the HMD unit 28 in a toe-in, toe-out setup or other setups. To allow a stereoscopic view, at least some of the right and left images should overlap. Such overlapping may occur when the right and left cameras 43 or the right and left cameras' FOVs at least partially converge. An actual FOV of a camera may be determined, for example, by defining a crop region or an image region on the camera sensor. In a parallel setup of cameras, such overlap may not occur or may be insignificant at planes which are substantially or relatively close to the cameras (e.g., at a distance of 0.5 meter, 0.4 to 0.6 meters, or up to one meter from the user, such as when displaying images of a patient surgical site or treatment or diagnosis site to a surgeon or a medical professional while he is operating on, treating or diagnosing the patient).

A digital convergence may be generated by horizontally shifting the crop region or image region on the cameras' sensors. A crop region or an image region including a set or subset of pixels may be determined on the sensor of each camera such that a full overlap between the right and left images (e.g., with respect to a plane of the ROI substantially parallel to a frontal plane of the user's head) is received at a determined distance from the ROI, e.g., from the determined plane of the ROI. The crop or image regions of the right and left cameras sensors may be identical in size (to receive same image size) and may be, according to some embodiments, initially located in a symmetrical manner around the centers of the sensors. A digital convergence may be generated at a determined distance from the ROI by changing, relocating, or horizontally shifting each of the crop or image regions of the cameras' sensors, e.g., to an asymmetrical location with respect to the corresponding sensor center. Furthermore, the crop or image regions may be changed or shifted such that a complete or full image overlapping is received at a determined distance from the ROI, e.g., while the user or wearer of the head-mounted unit 28, 70 is standing at that distance, looking straightforward at the ROI and while the camera's plane or a frontal plane of the user's head is parallel to the ROI plane. A full image overlap may be received when the scene displayed by one image is identical or the same (or substantially identical or the same) as the scene display by the other image, e.g., with respect to a plane of interest (an ROI plane). Such a full image overlap may allow the user to receive maximal information available by the configuration of the cameras (e.g., sensors FOV (or angular FOV) determined by the crops or image regions of the sensors).

In accordance with some embodiments, the cameras setup may not be parallel, and such that a digital convergence will not be required at a desired range of distances. However, such a setup may have effects, such as vertical parallax, which may significantly reduce the quality of the stereoscopic display, in some embodiments.

In a parallel setup, a convergence and advantageously full overlap plane distance and corresponding sensor crop regions may be predetermined. Such a distance will be referred to herein as the default distance. For example, for a surgery setting, this may be the typical working distance of a surgeon 22 wearing the HMD unit 28, 70 from the surgical site or ROI 24. A full images overlap allows the user (e.g., wearer of the HMD unit 28, 70) to receive the maximal information allowed by the configuration of the cameras 43 (e.g., actual sensors FOV).

Accordingly, the calibration process as described in and with respect to FIG. 6, may include calibration such that the default or initial focus value will be a focus value corresponding to the default distance. The calibration of the cameras may be with respect to the determined sensor crop regions. The real time adjustment as described hereinbelow with reference to FIG. 8, may be performed with respect to the determined default distance and sensor crop regions.

FIGS. 7A, 7B, and 7C are schematic figures illustrating the operation of cameras 43, in unit 28, 70, after the calibration described above for the flowchart of FIG. 6 has been performed, in accordance with an embodiment of the disclosure. The figures are top-down views, so that a plane 200 of the paper corresponds to a plane parallel to an axial or horizontal plane of the head of professional 26. Cameras 43 are disposed in a parallel setup.

After the calibration of FIG. 6, a left camera 43L and a right camera 43R are assumed to lie in an intersection of plane 200 with a plane 202 parallel to the frontal or coronal plane of the head of professional 26, and the cameras are assumed to be separated by a distance b, positioning cameras 43L and 43R as left and right cameras, respectively, with respect to the head of the user wearing the HMD, as is shown in FIG. 7A. The calibration may also correct for any vertical misalignment of cameras 43L and 43R, so that the situation illustrated in FIG. 7A, wherein the cameras are on a plane parallel to a horizontal plane of the head of professional 26, holds. In the figure, a line of symmetry O_{S}L_{S} between the two cameras, orthogonal to plane 202 and lying in plane 200, has been drawn. In some embodiments, line O_{S}L_{S} lies substantially on the median plane of the head of professional 26.

An enlarged view of elements of camera 43L is illustrated in FIG. 7B. The cameras 43L, 43R are assumed to view at least a portion of plane 204 (e.g., a plane of interest), parallel to the frontal or coronal plane of the professional, and at least a portion of it (e.g., the portion viewed by the cameras) is assumed to be included in the ROI 24 and FOV 22 (FIG. 1). Plane 204 is at a distance d from plane 202. Plane 204 is shown as a line, where the plane 204 intersects plane 200, in FIG. 7A. It will be understood that lines and line segments drawn on plane 200 and described herein may be representative of planar regions of elements that are above and below plane 200. For example, a line segment GF (described further below) is representative of a planar region GF, comprising elements on plane 204 that are above and below plane 200.

As illustrated in FIG. 7B, camera 43L has a sensor 210L, upon which a lens 214L of the camera focuses images from the plane 204, and the sensor 210L is separated from the lens 21L by a distance z, which is approximately the focal length of the camera 43L. In some embodiments, the sensor 210L is formed as a rectangular array of pixels 218. While the overall field of view of the camera 43L in both horizontal and vertical directions is typically defined by the overall dimensions of the sensor 210L and its distance z from the lens 214L, in the following description the field of view of camera 43L is assumed to be reduced from the overall field of view and is predefined as the image field of view. In some embodiments, the reduction is implemented by only generating images viewed by the camera from a subset 220 of the pixels 218, which will also be referred as the crop region or image region of the sensor, e.g., sensor 210L. The subset 220 may be selected during the calibration process of FIG. 6, and in this specific configuration the subset is assumed to be distributed symmetrically with respect to an optic axis OC_{L} of the camera 43L, wherein C_{L} is a center of lens 214L and O is a center of subset 220. Optic axis OC_{L} is also herein labeled as line 230L. FIG. 7B shows horizontal portions of the subset 220 (there are similar vertical portions of the subset 220, not shown in the figure). In some embodiments, the subset 220 has a horizontal right bounding pixel 224, also referred to herein as pixel A, and a horizontal left bounding pixel 228, also referred to herein as pixel B. In some embodiments, the pixels 224 and 228 may define an image horizontal angular field of view (HAFOV) 232L, having a magnitude α, for camera 43L. The image HAFOV 232L can be symmetrically distributed with respect to the optic axis OC_{L}, having a right horizontal bounding line 240L and a left horizontal bounding line 244L.

Referring now to FIG. 7A, HAFOVs 232L and 232R may overlap on the plane 204. The overlapping is indicated by section or line EF on line indication 204. The location of the plane 204 is determined by distance d. For distances d other than the one illustrated in the figure, the size of the overlapping portion or planar portion on the plane 204 would change (in the specific configuration, the greater d is, the greater the overlapping planar portion would be). For different distances, the length of the intersection between the overlapping planar portion and the plane 204 (indicated as EF) may be calculated (e.g., using basic trigonometry) or measured and mapped in the calibration phase (see FIG. 6). The intersection may be then translated to sensor pixels length and location within the sensor image region (e.g., indicated as segment or array AB in FIG. 7B). That is to say, for any given distance d, a segment or subset of image region AB corresponding to the planar portion indicated by EF may be calculated or identified. The image portion generated by this corresponding subset of pixels of the sensor image region may be then shifted on displays 30, 72 such that the center of these overlapping image portions would be aligned with the centers of the displays. Discarding of non-overlapping image portions may be also performed, as disclosed herein. According to some embodiments, the image regions on the sensors may be reduced to include only the portion or array of pixels corresponding to the overlapping planar portion.

Referring back to FIG. 7B and according to some embodiments, during operation of the HMD, such as unit 28 or 70, and as is described further below, pixel A may be shifted to a shifted horizontal right bounding pixel A_{S}, and pixel B may be shifted to a shifted horizontal left bounding pixel B_{S}. Pixels A_{S} and B_{S}, together with center C_{L}, respectively define shifted right horizontal bounding line R240L and shifted left horizontal bounding line R244L. In some embodiments, the two shifted bounding lines R240L, R244L define a shifted or horizontally relocated image HAFOV R232L. Image HAFOV R232L is no longer symmetrical with optic axis OC_{L}.

Camera 43R is constructed and is implemented to have substantially the same structure and functionality as camera 43L, having, as indicated in FIG. 7A, a sensor 210R separated by a distance z from a lens 214R, and the lens has a center CR. The pixels of sensor 210R are configured, as for sensor 210L to define an image HAFOV 232R for the camera of magnitude α. As for the image HAFOV of camera 43L, image HAFOV 232R is symmetrically distributed with respect to an optic axis 230R of camera 43R, having a right horizontal bounding line 240R and a left horizontal bounding line 244R. During operation of the HMD, such as unit 28 or 70, the bounding lines may be shifted to a shifted right horizontal bounding line R240R and a shifted left horizontal bounding line R244R (shown in FIG. 7C). The shifted bounding lines define a shifted or horizontally relocated image HAFOV for camera 43R, which, as for camera 43L, is no longer symmetrical with optic axis 230R.

FIG. 7A illustrates the initial horizontal angular fields of view of both cameras 43L and 43R, and it is assumed that the calibration process of FIG. 6 aligns optic axes 230L and 230R to be parallel to each other, and to be orthogonal to plane 202. Each of cameras 43R and 43L HAFOV (e.g., 232R and 232L, respectively) may include an intersection line with a defined ROI plane substantially parallel to the plane on which cameras 43R and 43L are disposed (e.g., plane 204 parallel to plane 202 and including intersection lines ED and GF, respectively). In some embodiments, each of cameras 43R and 43L may image a respective portion of the ROI plane 204. In the situation illustrated in the figure, camera 43R images a planar region between points D and E on plane 204, including intersection line DE, and camera 43L images a horizontal planar region between points F and G on the plane 204, including intersection line GF. In some embodiments, or during some instances of the operation of the HMD (e.g., HMD 28 or 70), the cameras (e.g., cameras 43R and 43L) may not image the entire horizontal planar region defined by the virtual intersection between the HAFOV (e.g., 232R and 232L, respectively) and the ROI plane (e.g., plane 204; the planar region defined by points D and E and G and F, respectively). For example, a portion of the defined planar region on plane 204 may be concealed or blocked by the scene. Since in at least some embodiments, the ROI plane would be typically defined by a visual element of the scene (e.g., a visual element captured by the cameras), at least a portion of the ROI plane or at least a portion of the horizontal planar region would be imaged. It will be understood that, while in the illustrated example there is a partial overlap between planar regions DE and FG, i.e., planar region EF, the amount of overlap depends on the values of b, d, and a. Furthermore, in some cases, e.g., cases where plane 204 is closer to plane 202 than that illustrated, there may be no overlap of the two images. In both cases, it will be appreciated that the images generated by the pixels of sensors 210R and 210L have at best a partial overlap, and in some cases may have no overlap.

Considering camera 43L, triangle ABC_{L} is similar to triangle FGC_{L}, so that ratios of lengths of corresponding sides of the triangles are all equal to a constant of proportionality, K, given by equation (1):

$$K = \frac{z}{d} \qquad ( 1 )$$

where z is a lens-sensor distance of the camera, and
d is the distance from the camera to plane 204.

The value of z in equation (1) varies, when the camera is in focus, according to distance d, as given by equation (1a):

$$z = ( \frac{f \cdot d}{d - f} ) \qquad ( 1 a )$$

where f is the focal length of the camera.

It will be understood that the ratio given by equation (1) applies to any horizontal line segment on plane 204 that is focused and may be imaged onto sensor 210L by the camera. E.g., the length of the line on sensor 210L, corresponding to the number of pixels imaged by the sensor, may be found using the value of K and the length of the line segment on plane 204.

Since camera 43R has substantially the same structure as camera 43L and is positioned similarly to camera 43L the ratio given by equation (1) also applies to any horizontal line segment on plane 204 that is imaged onto sensor 210R by camera 43R.

The value of K may be determined, for different values of distance d, from a calculated value of z using equation (1a), for camera 43L, and may be verified in the calibration described above with reference to FIG. 6.

The description above describes how the pixels of sensors of cameras 43L and 43R may generate respective different images of a scene on the plane 204.

FIG. 7C illustrates how, in embodiments of the disclosure, a processor, e.g., processor 52, may alter or cause the altering of the pixels acquired from the sensors, e.g., sensors 210L and 210R, of the cameras, e.g., cameras 43L and 43R, so that the intersection lines of the HAFOV of each of the cameras with the ROI plane (e.g., plane 204) are substantially identical (e.g., intersection line QP). Accordingly, images generated by the cameras by altering the acquired pixels (e.g., pixels from which information is acquired or read out) from the sensors, respectively, include or show a substantially identical portion of the ROI plane. In the specific example shown in FIGS. 7A-7C, processor 52 may alter or cause the altering of the pixels acquired from the sensors 210L and 210R of cameras 43L and 43R so that the two images acquired by the two sets of altered pixels are substantially identical. For camera 43L, the horizontal bounding pixels A, B of sensor 210L are shifted so that bounding lines 244L and 240L, defined by the bounding pixels, rotate clockwise around lens center C_{L} of camera 43L, respectively to new bounding lines R244L and R240L. The shifted bounding pixels of pixels A, B, are respectively identified as pixels A_{S}, B_{S}.

The rotation of line 244L to R244L is assumed to be by Δα₁, and the rotation of line 240L to R240L is assumed to be by Δα₂. After the rotation, the shifted pixels on sensor 210L image a line segment QP, where Q is an intersection point of line R244R with plane 204, and P is an intersection point of line R240R with the plane. Δα₁ and Δα₂ are selected so that line segment QP is symmetrically disposed with respect to cameras 43L and 43R, e.g., so that line segment QP is bisected by line of symmetry O_{S}L_{S}.

Processor 52 may also apply or cause to apply a similar shift to the pixels of sensor 210R of camera 43R, so that there is a rotation of bounding line 240R to bounding line R240R by Δα1, and a rotation of line 244R to bounding line R244R by Δα₂. The rotations of the bounding lines of camera 43R are about the center of lens 214R of the camera, and in contrast to the rotations for camera 43L, the rotations of the bounding lines of camera 43R are counterclockwise. After the rotations, bounding line R240R intersects plane 204 at P, and bounding line R244R intersects plane 204 at Q, so that the shifted pixels on sensor 210R also image QP.

The rotations of the bounding lines correspond to rotating the fields of view defined by the bounding lines, and the rotations are about the center of the lenses of the cameras.

To evaluate the shifts or relocation required for the pixels of the sensors (e.g., a shift or relocation of the image region of the sensor, the image region including an array of pixels), processor 52 evaluates lengths of line segments on plane 204 that the shifts have caused, e.g., for camera 43L and sensor 210L, the length of at least one of line segments GQ and FP. It will be appreciated that these lengths depend on d, Δα1, and Δα₂. Once the values of lengths GQ and FP have been determined, the processor is able to use the ratio given by equation (1) to determine the corresponding shift or relocation required on sensor 210L to achieve the desired intersection line.

Because of the symmetry of the system with respect to line O_{S}L_{S}, in some embodiments, the processor 52 is able to use substantially the same evaluations as those performed for camera 43L and sensor 210L for camera 43R and sensor 210R, so as to determine shifts or relocation corresponding to line segments PD (corresponding to GQ) and EQ (corresponding to FP) for sensor 210R.

In FIG. 7C, the points T, Z are described in the Appendix below.

### First Exemplary Embodiment, Δα₁=Δα₂

In some embodiments, Δα1 and Δα₂ are constrained to be equal, and are herein termed Δα, and in this case processor 45, 52 is able to evaluate lengths GQ and FP, and corresponding lengths on sensor 210L, as follows.

For camera 43L assume optic axis 230L cuts the plane 204 at a point S. From triangle C_{L}SG:

$$G Q = d \cdot tan ( \frac{α}{2} ) - d \cdot tan ( \frac{∝}{2} - Δ ∝ ) \qquad ( 2 )$$

From triangle C_{L}SP:

$$FP = d \cdot tan ( \frac{α}{2} + Δ ∝ ) - d \cdot tan ( \frac{∝}{2} ) \qquad ( 3 )$$

GQ corresponds to BB_{S}, and FP corresponds to AA_{S}, so applying equation (1) to equations (2) and (3) gives:

$$B {B}_{s} = \frac{z}{d} \cdot [ d \cdot tan ( \frac{α}{2} ) - d \cdot tan ( \frac{∝}{2} - Δ ∝ ) ] = z \cdot [ tan ( \frac{α}{2} ) - tan ( \frac{∝}{2} - Δ ∝ ) ] \qquad ( 4 )$$

$$and$$

$$A {A}_{s} = \frac{z}{d} \cdot [ d \cdot tan ( \frac{α}{2} + Δ ∝ ) - d \cdot tan ( \frac{∝}{2} ) ] = z \cdot [ tan ( \frac{α}{2} + Δ ∝ ) - tan ( \frac{∝}{2} ) ] \qquad ( 5 )$$

Even ignoring the fact that z is a function of d, as shown in equation (1a), it will be understood that the value of Δα, and thus the values of BB_{S} and AA_{S}, depend on d. An expression for Δα, in terms of d, is provided in the expression (A6) in the Appendix to this disclosure, below, and in operating unit 28 for this first exemplary embodiment processor 45, 52 uses the expression and equations (4) and (5) to evaluate the pixel shift BB_{S} and AA_{S} for sensor 210L of camera 43L for a given value of d. The processor 45, 52 can also apply the same pixel shifts to sensor 210R of camera 43R.

By setting Δα1 and Δα2 to be equal (to Δα) the numerical value of the angular HFOV before the shift described above is equal to the numerical value of the angular HFOV after the shift, being equal to α. However, the lengths of the intersection line of the HAFOVs with the ROI plane, e.g., plane 204, may not be equal, e.g., in FIG. 7C, for camera 43L GF≠QP; also GQ≠FP. Similarly, for camera 43R, DE≠QP; also PD≠EQ.

### Second Exemplary Embodiment, Δα₁≠Δα₂

In some embodiments, rather than Δα₁ being constrained to equal Δα₂ the lengths of the intersection lines between the HAFOVs and the ROI plane, e.g., plane 204, are constrained to be equal, before and after the pixel shifts or relocation. Thus, DE=GF=QP. In some embodiments, this constraint may be approached by symmetrically and separately rotating a pair of the AFOVs horizontal bounding lines, while each pair includes one horizontal bounding line of each one of the right and left AFOV. A first pair may be rotated by Δα1 and the second pair may be rotated by Δα2.

In the exemplary configuration illustrated in FIG. 7C, horizontal bounding line 244L and horizontal bounding line 240R are symmetrically rotated and in an opposing manner by Δα1 and horizontal bounding line 240L and horizontal bounding line 244R are symmetrically rotated and in an opposing manner by Δα2.

It should be noted that, for example, in other embodiments, horizontal bounding line 244L and horizontal bounding line 244R may be symmetrically rotated and in an opposing manner by Δα1 and horizontal bounding line 240L and horizontal bounding line 240R may symmetrically rotated and in an opposing manner by Δα2. In accordance with other embodiments, one pair of horizontal bounding lines of the right and left AFOVs may be symmetrically rotated and in an opposing manner by Δα1 while only one of the other pair of horizontal bounding lines may be rotated by Δα2. In further embodiments, each such pair of horizontal bounding lines may not be rotated in a symmetrical manner. There are various possibilities to approach this problem which may be applied by a professional skilled in the art, all of which are in the scope of the application.

In the specific configuration illustrated in FIGS. 7A-7C, camera 43L and camera 43R are disposed in a parallel layout (e.g., plane 202 parallel to plane 204 and optic axes 230L and 230R are parallel and orthogonal to planes 202 and 204):

$$G Q = P D = E Q = F P = \frac{b}{2} \qquad ( 6 )$$

Applying equation (1) to equation (6), so as to obtain expressions for AA_{S} and BB_{S}, gives:

$$A {A}_{s} = B {B}_{s} = \frac{z b}{2 d} \qquad ( 7 )$$

As is seen from equation (7) the values of BB_{S} and AA_{S}, are approximately inversely proportional to d (z is a function of d, as shown in equation (1a), so the proportionality is not exact). In operating unit 28 for the second exemplary embodiment processor 45, 52 uses equation (7) to evaluate the pixel shift BB_{S} and AA_{S} for sensor 210L of camera 43L for a given value of d, and can apply the same pixel shifts to sensor 210R of camera 43R.

In contrast to the first exemplary embodiment, in the second exemplary embodiment the numerical value of the angular HFOV before the shift, a, is not equal to the numerical value of the angular HFOV after the shift. But in the second exemplary embodiment the lengths of the linear elements of plane 204 imaged by the two fields of view are equal, i.e., as stated above, for camera 43L GF=QP, and for camera 43R DE=QP.

With reference to FIG. 7B, in some embodiments, only Δα1 and its corresponding sensor image region shift, or relocation, may be calculated. The image region may be then shifted as a whole by the calculated shift. Since the distance z is relatively small, it is assumed that the shift length corresponding to rotating 240L by Δα2 when Δα1=Δα2 is substantially equal to the shift corresponding to Δα1 (or that the pixel length difference is negligible).

FIG. 8 is a flow chart that schematically illustrates a method for generating a stereoscopic digital loupe display, in accordance with an embodiment of the disclosure. This method receives as its inputs a stream of infrared images or video images (e.g., block 162) output or any other output by distance sensor or tracking device 63 and respective streams of images, e.g., RGB images or color video images (e.g., blocks 164, 166) that are output by the left and right cameras, e.g., color cameras 43, along with calibration data generated (e.g., calculated) and stored as described in step 160 in connection with FIG. 6. Left camera and right camera may have the same frame rate, e.g., 60 frames per second. In some embodiments, left camera image capturing and/or image stream 164 and right camera image capturing and/or image stream 166 may be synchronized. In some embodiments, tracking camera, e.g., IR camera image capturing and/or image stream 162, left camera image capturing and/or image stream 164 and right camera image capturing and/or image stream 166 are synchronized. In a setting in which the distance between the cameras and the ROI or at least the ROI plane does not change rapidly, for example, the distance between a surgeon wearing the HMD and a surgical site during a medical procedure, there may be an offset between the capturing and/or image streaming of right and left cameras. One or more processors, e.g., processor 45, 52 processes infrared video images or other input from block 162 in order to extract distance information at a distance extraction step 170. In some embodiments, the processor 45, 52 calculates the distance from each of the cameras (e.g., from each of cameras 43) to ROI 24 (e.g., a plane of ROI 24) based on the extracted distance from the distance sensor or tracking device 63 (e.g., infrared camera of the distance sensor or tracking device 63) to the ROI 24, e.g., using the registrations calculated at steps 150 and 152 of FIG. 6, correspondingly, at a distance calculation step 172.

In some embodiments, the processor 45, 52 then sets the focusing parameters or values of cameras 43 to match the distance to ROI 24 (e.g., a plane of ROI 24), based on calibration data generated at step 160, at a focusing step 174. In some embodiments, as discussed further below, the focusing parameters or values may be set to not match the distance to ROI 24, such as to at least partially obscure the reality view of the ROI by setting different focal distances between the ROI and the displayed images.

Stereoscopic tuning may be performed via various systems and methods as described herein.

According to some embodiments, the processor 45, 52 may tune the stereoscopic display by shifting, (e.g., horizontally shifting) overlapping image portions of the right and left cameras (indicated by intersection line EF in FIG. 7A, for example) and optionally discarding the non-overlapping image portions. In some embodiments, the processor 45, 52 may apply the horizontal shift values in calibration maps, formulas or according to the mapping generated at step 160 of FIG. 6 in displaying the pair of images captured simultaneously or substantially simultaneously by right and left cameras, e.g., cameras 43, on right and left displays such as displays 30, correspondingly. In some embodiments, the horizontal shift formula, map or mapping values are configured such that in each distance the center of the overlapping portion in each image is shifted to the center of display portion (33) to reduce parallax and allow a better stereoscopic view and sensation. Thus, in accordance with several embodiments, the horizontal parallax between the centers of the overlapping image portions is zero or substantially zero. In some embodiments the horizontal shift value may correspond to the horizontal shift length (e.g., in pixels). In some embodiments, the horizontal shift value may correspond to the coordinates (e.g., in the display coordinate system) of the center pixel of the overlapping image portion. Furthermore, the non-overlapping image portions may be discarded. Portions of the non-overlapping image portions may be discarded simply due to the horizontal shift which places them externally to display portion(s) 33. Consequently, in some embodiments, these image portions may not be displayed to the user. The rest of the non-overlapping image portions or all of the non-overlapping image portions may be discarded, for example, by darkening their pixels and/or by cropping. In some embodiments, the discarding of non-overlapping portions of the images may be performed or may be spared by reducing the image regions on the image sensors of the left and rights cameras to include only the overlapping image portion. Method and systems for shifting, relocating, or altering the sensor's image portion are disclosed herein above.

According to some embodiments, the stereoscopic tuning may be performed by shifting, relocating, or altering the image sensors' image region to provide a substantially similar or identical images, at least with respect to a determined ROI image (a plane of substantially zero parallax) and to facilitate full overlap between the left and right images. It should be noted that for some embodiments the head of the user wearing the HMD is facing the ROI. However, in some embodiments where the distance between the HMD and the ROI is relatively close (e.g., for medical uses such as surgery, treatment or diagnosis of a patient and a distance up to one meter, for example) a head posture not parallel to the ROI may provide images substantially identical and/or having a negligible difference. In step 174 processor 45, 52 assumes that the distance is d, and may apply, for example, equations (4) and (5) according to one embodiment, or equation (6) for another embodiment, to determine the pixels to be shifted in sensors 210L and 210R, and the corresponding new sets of arrays of pixels in the sensors to be used to acquire images. Alternatively, rather than using the equations referred to above while operating unit 28, 70 to limit the pixels accessed, processor 45, 52 may store images acquired from the full arrays of pixels of sensors 210L and 210R as maps, and select images from the maps according to the equations. One having ordinary skill in the art will be able to change the description herein, mutatis mutandis, for this alternative process. In some embodiments, the eye trackers 44 may be employed to dynamically determine the ROI 24 by dynamically and repeatedly determining the user's gaze direction or line of sight. The dynamic determination of the sensors crop region or image region may then be dynamically or repeatedly determined also based on the current or simultaneously determined ROI.

In some embodiments, the result of this step is a stream of focused image pairs (block 176), having only or substantially overlapping or identical content, for proper stereoscopic presentation on displays 30, 72. By only using substantially overlapping or identical content, embodiments of the disclosure eliminate or lessen problems such as eye fatigue, headaches, dizziness, and nausea that may be caused if non-overlapping and/or different content is presented on the displays 30. The magnification of these stereoscopic image pairs is set to a desired value, which may be optionally adjusted in accordance with a user-controlled zoom input (block 178). Magnification may be achieved, for example, by using down sampling techniques. The resulting left and right magnified images (blocks 180, 182) are output to left and right displays 30, 72, respectively, and are updated as new images are captured and processed.

It should be noted that the process described in FIG. 8 except for step 160 may be repeatedly or iteratively performed (e.g., once in a predefined time interval and up to cameras 43 image capture rate), and such that images or a video of the captured ROI 24 is stereoscopically displayed on display 30, 72.

### Adjusting Visibility and/or Clarity of Reality when Using a Digital Loupe

Including a selectively activatable and/or adjustable digital loupe (e.g., a selectively activatable and/or adjustable magnified image) in a head-mounted display unit can have a number of benefits, including the various benefits discussed above. One potential problem with using such a digital loupe in a see-through or transparent display, however, is that reality may still be able to be seen through the see-through display while the magnified image is displayed, and since the magnified image and reality are at different levels of magnification, the magnified image being overlaid on reality may cause confusion and/or may result in a sub-optimal magnified image. Various embodiments of head-mounted display systems disclosed herein can address this problem by, for example, reducing the visibility and/or clarity of reality when the digital loupe or magnified image is activated. For example, various embodiments disclosed herein may include one or more adjustable display parameters that affect at least one of visibility or clarity of reality through a display with respect to images displayed on the display. As further described below, such adjustable display parameters may comprise an adjustable brightness level, an adjustable level of opaqueness, an adjustable focal distance, and/or the like.

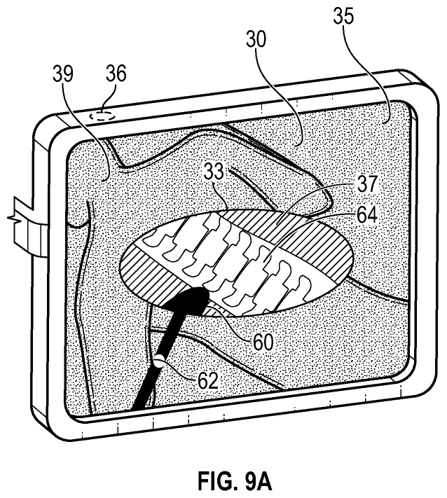

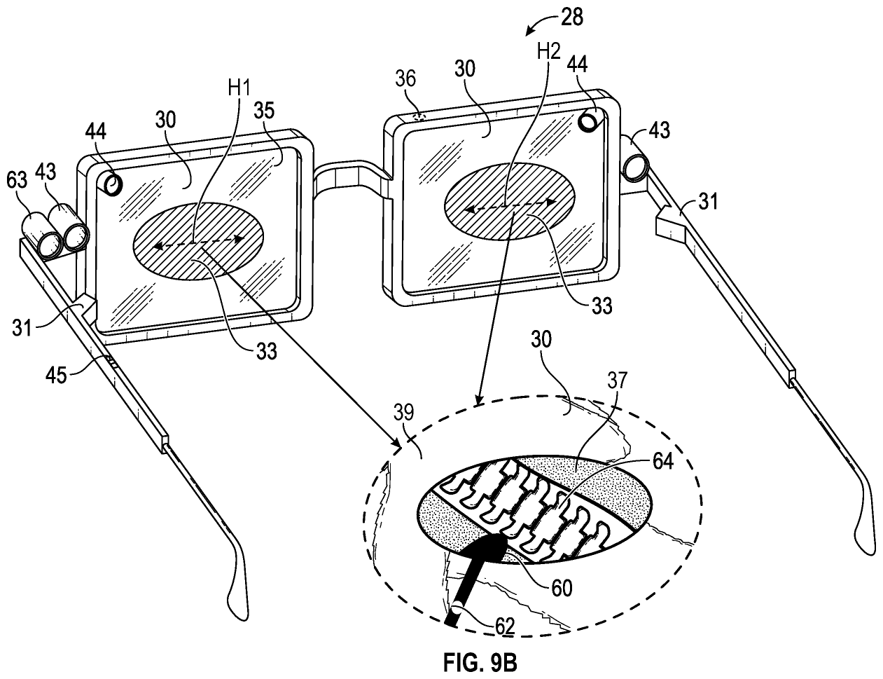

FIG. 9A illustrates schematically one display 30 of a head-mounted display unit (such as head-mounted display unit 28 of FIG. 2) and shows a magnified image 37 in first portion 33 of the display 30 and reality 39 somewhat visible through second portion 35 of the display 30. FIG. 9A is similar to FIG. 4, discussed above, and the same or similar reference numbers are used to refer to the same or similar components. One difference from FIG. 4, however, is that in FIG. 9A, the visibility of reality 39 through the display 30 has been reduced. Specifically, the display 30 has been made darker and/or more opaque than in FIG. 4. In a case where the magnified image 37 is projected onto the display 30 (such as via micro-projector 31 of FIG. 2) this can result in the magnified image 37 being significantly brighter than the image of reality 39 seen through the display 30. By changing the relative brightness of the magnified image 37 versus reality 39, specifically by increasing the relative brightness of magnified image 37 versus reality 39, this can result in a reduction of confusion and/or a more optimal magnified image.

Adjusting the relative brightness, such as by increasing the brightness of the magnified image 37 and/or reducing the brightness of reality 39 seen through display 30, can be accomplished in a number of ways. For example, the system may be configured to detect the brightness of the real world or reality 39 and adjust the brightness of the projected magnified image 37 such that the brightness of the magnified image 37 is greater than the detected brightness of reality 39. The brightness of reality 39 can be detected in a number of ways, including using an ambient light sensor, such as ambient light sensor 36 of head-mounted display unit 28, analyzing sensed RGB images from the cameras 43, and/or the like.

As another example, adjusting the relative brightness between the magnified image 37 and reality 39 can be accomplished by reducing the brightness of reality 39 visible through display 30 (such as by making display 30 more opaque), up to and including reducing the brightness of reality 39 to a point that reality can no longer be seen through display 30. For example, the display 30 may incorporate an electrically switchable smart glass, such as a polymer dispersed liquid crystal (PDLC) film, an electrochromic film, micro blinds, and/or the like. When the magnified image 37 is displayed, the system can be configured to activate and/or adjust the smart glass such that the display 30 becomes more opaque, darker, more tinted, and/or the like (as shown in FIG. 9A), thus resulting in an increased relative brightness of the magnified image 37 versus reality 39. In some embodiments, multiple techniques may be used together. For example, a smart glass film or the like may be used to darken or make more opaque the display 30, while the brightness of the magnified image 37 is also adjusted, in order to achieve a desired differential between the brightness of the magnified image 37 and of reality 39.

In some embodiments, the display 30 may be manufactured such that it includes a permanent tint that gives it at least some opaqueness at all times. Such a design could help to ensure that a magnified image 37 projected onto the display 30 is always brighter than reality 39, without necessarily having to detect and adjust for an ambient light level. Such a design may also be used in combination with other features disclosed herein, such as active adjustment of the brightness of the magnified image 37 based on a detected ambient light level, and/or active control of the level of tint or opaqueness of the display 30.

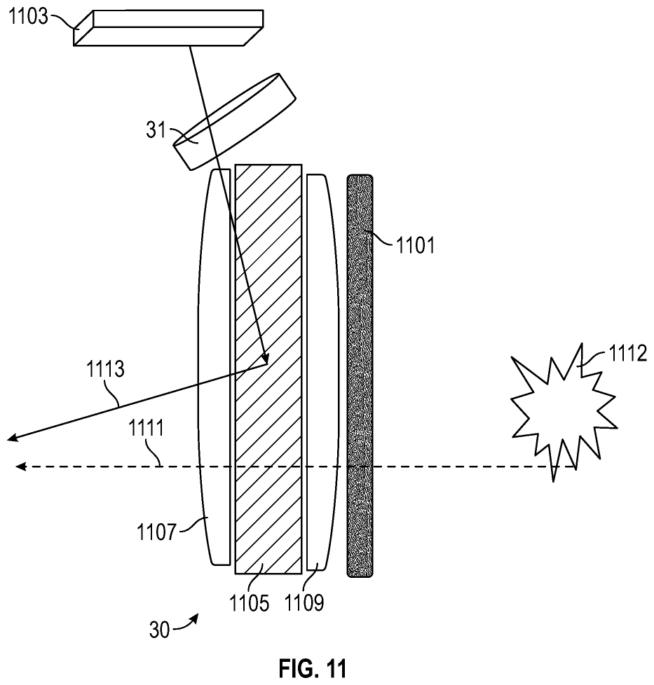

Another way various embodiments disclosed herein can darken reality is to utilize a neutral density optical filter. For example, a neutral density filter may be placed in front of a lens of the display 30, a neutral density filter may be built into the display 30, a neutral density coating may be applied to a lens of the display 30, and/or the like. Further details of examples of such embodiments are provided below with reference to FIGS. 11-13.

Another way various embodiments of systems disclosed herein can reduce the clarity and/or visibility of reality with respect to a magnified image is to change the focal distance of the magnified image such that the focal distance is different than reality (e.g. different than the focal distance of the ROI plane). Such a feature can be used alone or in combination with any of the other features disclosed herein, such as adjusting a relative brightness of the magnified image with respect to reality.

Turning to FIG. 9B, this figure illustrates schematically an example of adjusting the focal distance of a magnified image 37 such that the focal distance is different than reality, causing reality 39 to be out of focus when the user (e.g., wearer of head-mounted display unit 28) is focused on the magnified image 37. For example, the magnified images 37 projected onto the left and right displays 30 may each be adjusted in a horizontal direction H1, H2, respectively, in order to adjust the focal distance of the magnified image as seen by the user (e.g., wearer of head-mounted display unit 28), such that the focal distance is greater than or less than the focal distance of the ROI plane (see, e.g., ROI plane focal distance d of FIG. 7C).

The horizontal shifting of the magnified images 37 (e.g., the adjusting of disparity of the images) may be accomplished in a number of ways, including using any of the horizontal shifting techniques discussed above. For example, the crop region or subset of pixels 220 used by each camera may be adjusted (see FIG. 7B). As another example, the positions at which the magnified images 37 are projected onto the displays 30 may be adjusted.

In some embodiments, a digital loupe as disclosed herein may be configured to allow a user (e.g., wearer of head-mounted display unit 28) to select from multiple levels of magnification (such as, for example, 1× or no magnification, 1.5× magnification, 2× magnification, 3× magnification, 4× magnification, 5× magnification, 6× magnification, 7× magnification, 8× magnification, 9× magnification, 10× magnification, 15× magnification, 20× magnification, 25× magnification, 50× magnification, 100× magnification, greater than 100× magnification, 1.5× to 10× magnification, 5× to 20× magnification, 2× to 8× magnification, 10× to 50× magnification, 40× to 100× magnification, overlapping ranges thereof, or any values within the recited ranges and/or the like). In some embodiments, the system may be configured to obscure reality (e.g., reduce visibility and/or clarity of reality) when any magnification level other than 1× is selected. In some embodiments, the same level of obscurity (e.g., the same amount of reduction in visibility and/or clarity) is used for all levels of magnification other than 1×. In some embodiments, however, the level of obscurity (e.g., the amount of reduction in visibility and/or clarity) may be higher for higher levels of magnification than for lower levels of magnification.

FIG. 10 is an example embodiment of a process 1000 for obscuring reality (e.g., reducing visibility and/or clarity of reality) when a digital loupe is activated. The process 1000 can be stored in memory and executed by one or more processors of the system (e.g., one or more processors within the head-mounted display unit 28 or separate). The process flow starts at block 1001, where a head-mounted display unit, such as head-mounted display unit 28 of FIG. 2, may be configured to generate and output unmagnified images, which may include augmented reality images, on see-through displays aligned with reality. This may correspond to outputting images in a first magnification mode, with the desired level of magnification in the first magnification mode being 1× or no magnification. In such an operating mode, an adjustable display parameter (such as a parameter associated with brightness, opaqueness, focal distance, and/or the like, as discussed above) may be set to a first configuration, such as a configuration that does not obscure the ability of the user (e.g., wearer of head-mounted display unit 28) to see reality through the see-through display.

At block 1003, the system receives a request to magnify the images, and/or to activate the digital loupe. For example, a user of the system user (e.g., wearer of head-mounted display unit 28) may request activation of magnification using a user interface, as discussed above. At block 1005, the system can generate and output magnified images on the see-through displays, such as magnified images 37 shown in FIGS. 4, 9A, and 9B, discussed above. Sequentially or concurrently, at block 1007, the system may reduce the visibility and/or clarity of reality through the see-through displays with respect to the magnified images. This may correspond to outputting images in a second magnification mode, with a desired level of magnification in the second magnification mode being greater than 1×. In such an operating mode, the adjustable display parameter may be set to a second configuration, such as a configuration that at least partially obscures the ability of the user (e.g., wearer of head-mounted display unit 28) to see reality through the see-through display. For example, the system may be configured to increase the relative brightness of the magnified image 37 with respect to reality 39, as discussed above with reference to FIG. 9A. Alternatively or additionally, the system may, for example, be configured to change the focal distance of the magnified image 37, such that reality 39 will be out of focus when the user (e.g., wearer of head-mounted display unit 28) is focusing on the magnified image 37, as discussed above with reference to FIG. 9B.

At block 1009, the system receives a request to stop magnification of the images, and/or to deactivate the digital loupe. For example, a user of the system user (e.g., wearer of head-mounted display unit 28) may request deactivation of the magnification using a user interface, as discussed above. At block 1011, the system may again generate and output unmagnified images on see-through displays aligned with reality, similar to as in block 1001. Sequentially or concurrently, at block 1013, the system can increase the visibility and/or clarity of reality through the see-through displays with respect to the unmagnified images. For example, the system may fully or partially reverse the changes made at block 1007, such as by decreasing the relative difference in brightness between magnified image 37 and reality 39, decreasing the opaqueness of the display, reverting the focal distance of the displayed images to be closer to or equal to reality, and/or the like. The process flow then proceeds back to block 1003 and proceeds as described above.

### Neutral Density Filters

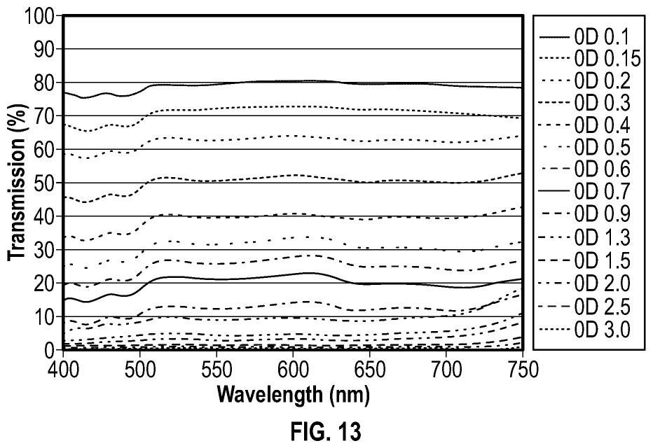

As discussed above, one way to darken reality with respect to a magnified image is to include a neutral density optical filter. In accordance with several embodiments, a neutral density filter is a type of filter that exhibits a flat or relatively flat transmission ratio across a relatively wide range of light wavelengths. For example, with reference to FIG. 13, this chart shows the percentage of light transmission by wavelength with neutral density filters having various neutral density factors, from 0.1 to 3.0. For example, as shown in this chart, a neutral density factor of 0.1 results in the filter transmitting approximately 80% of light therethrough, and a neutral density factor of 0.4 results in the filter passing approximately 40% of light therethrough.

FIG. 11 schematically illustrates one display 30 having a neutral density filter 1101 positioned in front of the display 30. The display 30 may be the same as or similar to other displays disclosed herein, such as display 30 of FIG. 9A. FIG. 11 shows that, in this embodiment, the display 30 includes a waveguide lens 1105 with a posterior lens 1107 behind the waveguide lens 1105, and an anterior lens 1109 in front of the waveguide lens 1105. Further, a projector 31, such as a micro projector, can project an image generated by display 1103 toward the waveguide lens 1105, for projection toward the eyeball of the user (e.g., wearer of head-mounted display unit 28) through posterior lens 1107.

FIG. 11 also includes two arrows 1111 and 1113 indicative of the luminance being transmitted to the user from the background (e.g., from environmental light 1112) and from the projector 31, respectively. The contrast of the image projected by the projector 31 can be degraded by a superimposed image of reality through the see-through component, which transmits the ambient background luminance 1111 through the display 30. Addition of a neutral density filter 1101 that reduces the background luminance 1111 can fully or partially counteract such contrast degradation.

The transmission ratio of the neutral density filter 1101 can be selected to reduce such degradation and/or to optimize the see-through contrast ratio. The see-through contrast ratio represents a ratio of the luminance coming from the augmented reality system (e.g., luminance 1113) to the luminance coming from the background or external scene (e.g., luminance 1111). The see-through contrast ratio can be calculated using the following formula:

$$C R = \frac{T * B + L}{T * B}$$

where T is the transmission of the lens assembly for the background luminance (e.g., luminance 1111), based on the lens assembly/display 30 configuration and the neutral density filter 1101 transmission, B is the background luminance of the scene (e.g., regular room light or under an operating room light source), and L is the luminance from the near-eye-display (e.g., luminance 1113). In one example, a see-through contrast ratio of 1.4 is perceived as sufficient for a user to get a high-quality image on the background for augmented reality and heads up display systems. Such a see-through contrast ratio is not a requirement, however, and various embodiments may utilize neutral density filters having different levels of transmission that may result in a higher or lower than 1.4 see-through contrast ratio.

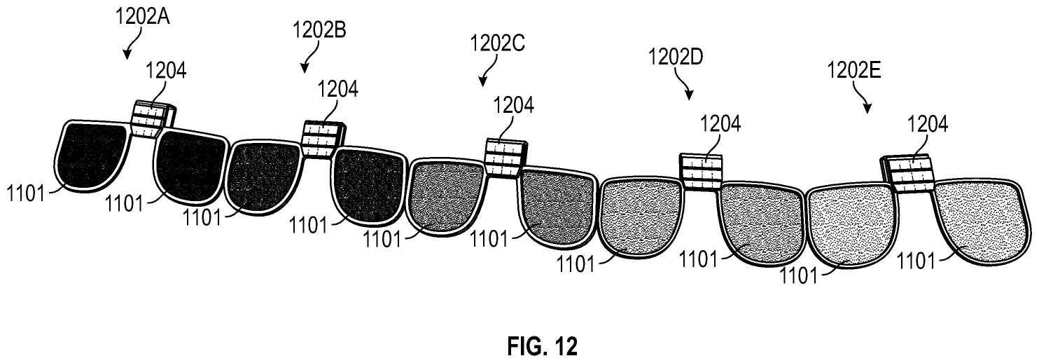

FIG. 12 illustrates one way of incorporating a neutral density filter into a head-mounted unit as disclosed herein. Specifically, FIG. 12 shows five different clip-on neutral density filter assemblies 1202A, 1202B, 1202C, 1202D, and 1202E. Each of these neutral density filter assemblies includes two neutral density filters 1101 (e.g., corresponding to the two displays 30 of head-mounted unit 28 of FIG. 2) and a clip 1204. The clip 1204 can be shaped and configured to clip onto a head-mounted unit, such as the head-mounted unit 28 of FIG. 2 or any other of the head-mounted units disclosed herein.

Each of the clip-on neutral density filter assemblies 1202A-1202E of FIG. 12 is configured to transmit a different amount of light, as can be seen by some of the neutral density filters 1101 appearing darker than others. It can be desirable to have a range of clip-on assemblies available that each have a different neutral density factor (e.g., corresponding to the various neutral density factors shown in FIG. 13), in order to allow a user to use an appropriate neutral density filter for the current operating environment, such as to obtain a desirable see-through contrast ratio. As discussed above, the see-through contrast ratio depends at least partially on the background luminance that passes through the neutral density filter. Accordingly, since different operating environments may have a different amount of environmental light 1112 (e.g., the ambient or environmental brightness may vary), it can be desirable to have neutral density filters 1101 of different neutral density factors in order to adapt to a particular environment. In some embodiments, the luminance 1113 provided by the projector 31 may also or alternatively be varied in order to adjust the see-through contrast ratio to a desirable level (for example, at or around 1.4).

Although FIG. 12 illustrates a configuration where neutral density filters can be clipped on to a head-mounted unit (e.g., removably attached thereto, removably coupled thereto, and/or the like), other configurations of neutral density filters can also be used. For example, neutral density filters may be configured to be removably attached or coupled to a head-mounted unit using something other than a clip (or in addition to a clip), such as magnets, friction, and/or the like. As another example, neutral density filters may be permanently affixed to a head-mounted unit. As another example, a neutral density coating may be applied to a portion of a head-mounted unit, such as to the anterior lens 1109 of FIG. 11.

### Toe-In Compensation

Various embodiments disclosed herein utilize shifting of pixels used in optical sensors (e.g., cameras 43) to facilitate focusing of stereo images at a particular plane (e.g., plane 204 of FIGS. 7A and 7B), when optical axes of the cameras (e.g., optical axes 230L and 230R) are parallel or substantially parallel to one another. In some embodiments, however, the cameras may be rotated or pivoted inward, such that their optical axes converge instead of being parallel to one another. In some embodiments, this may be referred to as a “toe-in” arrangement. Such an arrangement may be used as an alternative to the sensor shift techniques described above or may be used in combination with the sensor shift techniques described above.

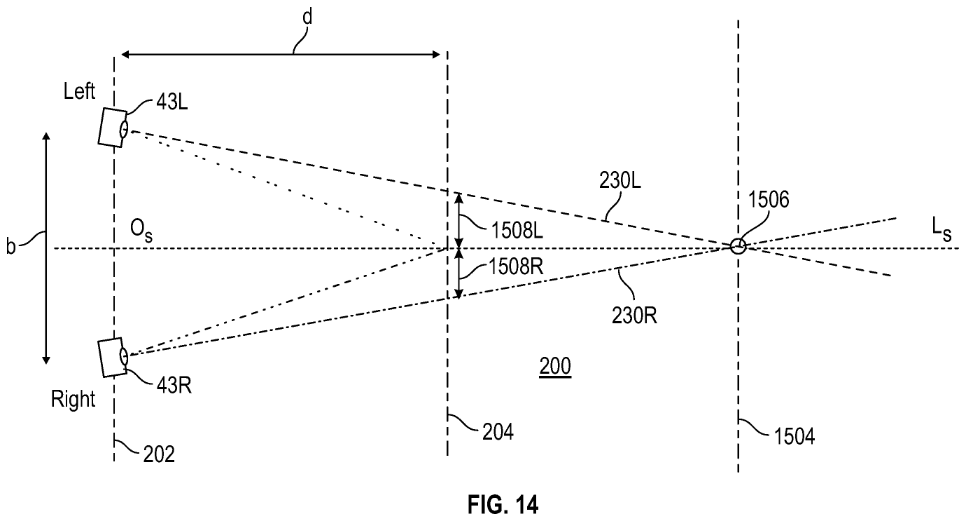

Turning to FIG. 14, this figure illustrates a similar arrangement to FIG. 7A, discussed above, and the same or similar reference numbers are used to refer to the same or similar features. One difference in the arrangement of FIG. 14, however, is that the left and right cameras 43L and 43R, respectively, have been pivoted or rotated inward such that their optical axes 230L, 230R converge at a mechanical convergence point 1506 that is at an intersection of plane 1504 and the line of symmetry between the cameras O_{S}L_{S}. In this embodiment, the cameras are toed in by an amount that puts the mechanical convergence point 1506 beyond the plane 204 that is positioned at the region of interest. In various embodiments and/or use cases, however, the mechanical convergence point 1506 may be positioned beyond the plane 204, in front of the plane 204, or coincident with the plane 204. Further, in some embodiments, the angle at which the optical axes 230L, 230R are positioned may be adjustable, such as to position the mechanical convergence point 1506 closer to plane 204. That said, adjustability of the angle at which the optical axes 230L, 230R are positioned is not a requirement, and the system may be configured to compensate for the mechanical convergence point 1506 not being coincident with the plane 204. For example, the system may be configured to be initialized and/or calibrated based on a particular position of the mechanical convergence point 1506 and/or plane 1504 and to use that calibration or initialization to generate functions that can determine or estimate the amount of sensor shift (e.g., left sensor shift 1508L of left camera 43L and right sensor shift 1508R of right camera 43R) needed to produce stereo images focused at plane 204.

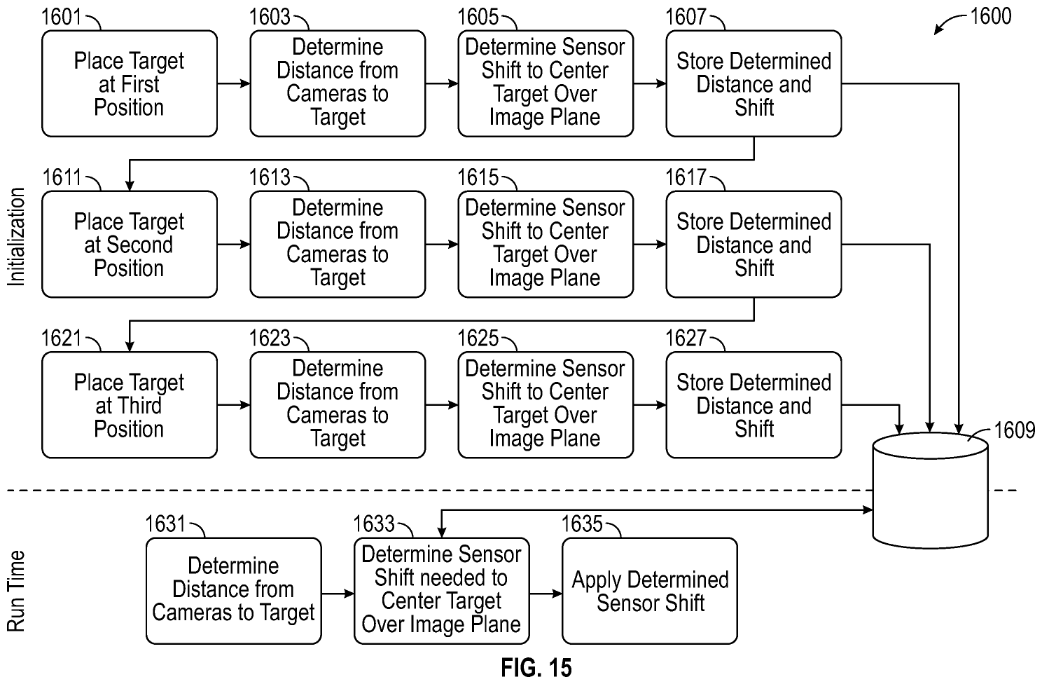

Turning to FIG. 15, this figure illustrates an embodiment of an initialization or calibration process that can be used to determine or estimate the sensor shifts 1508L, 1508R needed to focus a pair of stereo images at plane 204. In some embodiments, this process may be used as part of and/or in combination with the calibration process of FIG. 6 discussed above. The process shown in FIG. 15 can be used to generate functions that take a distance as an input and output an amount of sensor shift needed (e.g., Left Sensor Shift 1580L=f1(d); Right Sensor Shift 1580R=f1(d); where d is the distance between planes 202 and 204 of FIG. 14). In some embodiments, these functions incorporate and/or are embodied in a cross-ratio lookup table.

In general, the functions generated from this process are based on the cross-ratio principle and are generated by analyzing a target positioned at multiple positions, such as three, that are in a straight line and each a different distance from the cameras. For each of those positions, an amount of sensor shift of each camera that is needed to center the target (e.g., focus stereo images of the target) over the image plane is measured or determined and saved into a database, lookup table, and/or the like, along with the distance from the cameras. At runtime, a distance to a region of interest may be determined, and then the appropriate sensor shifts 1508L, 1508R may be determined based on that distance from the cross-ratio lookup table.

The above-summarized process is shown in more detail in FIG. 15. For example, at block 1601, a target is placed at a first position, such as at a first distance from the plane 202 of the cameras 43L, 43R. At block 1603, the first distance of that first position is determined. For example, in some embodiments, the distance may be known or predetermined (such as by using a setup fixture that has set, known distances), or in some embodiments a distance sensor may be used to determine the distance. Any techniques for distance determination disclosed elsewhere herein, including, without limitation, distance sensor or tracking device 63 discussed above and/or any techniques described in PCT International Application Publication No. WO2023/021448, titled “Augmented-Reality Surgical System Using Depth Sensing,” the disclosure of which is incorporated by reference herein, may be used to determine the distance. Next, at block 1605, the amount of sensor shift (e.g., left sensor shift 1508L and right sensor shift 1508R) needed to center the target over the image plane is determined. For example, the system may try different amounts of sensor shift until the target is focused over the image plane. At block 1607, the distance determined in block 1603 and the sensor shifts determined in block 1605 are stored in database 1609, such as being stored in a lookup table of the database 1609.

At blocks 1611, 1613, 1615, and 1617, the same or similar procedures conducted at blocks 1601, 1603, 1605, and 1607, respectively, are performed, but with the target placed at a second position that is a second distance from the cameras (different than the first distance). Finally, at blocks 1621, 1623, 1625, and 1627, the same or similar procedures conducted at blocks 1601, 1603, 1605, and 1607, respectively, are performed, but with the target placed at a third position that is a third distance from the cameras (different than both the first and second distances).

Once the initialization has been performed, the data stored in the lookup table of the database 1609 may then be used at runtime to determine appropriate sensor shifts 1508L, 1508R to focus images at plane 204. For example, at block 1631, the system may determine the distance from the cameras 43L, 43R to the target (e.g. to a region of interest at plane 204). This distance may be determined using the same or similar techniques as used for blocks 1603, 1613, and 1623. Next, at block 1633, the system may consult the lookup table stored in database 1609 to determine appropriate sensor shifts 1508L, 1508R based on the distance determined at block 1631. At block 1635, the determined sensor shifts may be applied, thus producing a stereo image focused at plane 204.

### Additional Depth Sensing Information

As discussed above, various embodiments can include functionality to sense, detect, determine, and/or estimate depth and/or distance. This functionality can include, for example, measuring disparity between images captured by left and right cameras, comparing the gaze angles of the user's left and right eyes, and/or using a distance sensor, depth sensor, and/or tracking sensor. This functionality can also include any depth or distance sensing, detecting, determining, or estimating methods, and devices for implementing such depth or distance sensing, detecting, determining, or estimating methods, described in PCT International Application Publication No. WO2023/021448, titled “Augmented-Reality Surgical System Using Depth Sensing,” the disclosure of which is herein incorporated by reference.

In some embodiments, the term “depth sensor” refers to one or more optical components that are configured to capture a depth map of a scene. For example, in some embodiments, the depth sensor can be a pattern projector and a camera for purposes of structured-light depth mapping. For example, in some embodiments, the depth sensor can be a pair of cameras configured for stereoscopic depth mapping. For example, in some embodiments, the depth sensor can be a beam projector and a detector (or an array of detectors), or other illumination sensors configured for time-of-flight measurement. Of course, the term “depth sensor” as used herein is not limited to the listed examples and can include other structures.

In addition to the use cases for depth and/or distance sensing, detection, determination, or estimation discussed above, such depth and/or distance sensing, detection, determination, and/or estimation can also be utilized for a variety of other use cases. For example, depth sensing, detection, determination, and/or estimation may facilitate calibration of non-straight instruments, haptic feedback, reduced effects of patient breathing on accuracy, occlusion capabilities, gesture recognition, 3D reconstruction of any shape or object, monitoring and quantifying of removed volumes of tissue, and/or implant modeling and registration without reliance on X-rays, among other things.

As another example, in some embodiments, it may be possible to 3D reconstruct any shape from a pair of stereo cameras (e.g., left and right cameras, such as cameras 43L and 43R, with known relative rigid translation and rotation). For example, implants, navigation tools, surgical tools, or other objects could be modeled and reconstructed in 3D by capturing left and right images of the same object and determining the pixel corresponding to the same object within the left and right images. Tools may include disc prep instruments and dilators, as well as interbody fusion tools, including rods, screws or other hardware. In some embodiments, the determined correspondences plus the calibration data (e.g., the cameras' relative transformation) advantageously make it feasible to 3D reconstruct any object. In accordance with several implementations, in order to fully 3D reconstruct an object, the depth sensing systems could capture left and right images of the object from multiple angles or views, with each angle or view providing a partial 3D point cloud of an implant, instrument, tool, or other object. The images from multiple angles or views (e.g., and associated respective partial 3D point clouds) could be combined or stitched together. After modeling an object, the systems could do various things with the modeled object including, among other things, calibrating the object into a reference marker, such as a marker affixed to a patient.

In some embodiments, the light source may comprise a structured light projector (SLP) which projects a pattern onto an area of the body of a patient on which a professional is operating. In some embodiments, the light source comprises a laser dot pattern projector, which is configured to apply to the area structured light comprising a large number (typically between hundreds and hundreds of thousands) of dots arranged in a suitable pattern. This pattern serves as an artificial texture for identifying positions on large anatomical structures lacking fine details of their own, such as the skin and surfaces of the vertebrae. In some embodiments, one or more cameras capture images of the pattern, and one or more processors process the images in order to produce a depth map of the area. In some embodiments, the depth map is calculated based on the local disparity of the images of the pattern relative to an undistorted reference pattern, together with the known offset between the light source and the camera. The artificial texture added by the structured light sensor could provide for improved detection of corresponding pixels between left and right images obtained by left and right cameras. In some embodiments, the structured light sensor could act as a camera, such that instead of using two cameras and a projector, depth sensing and 3D reconstruction may be provided using only a structured light sensor and a single camera.

In some embodiments, the projected pattern comprises a pseudorandom pattern of dots. In this case, clusters of dots can be uniquely identified and used for disparity measurements. In the present example, the disparity measurements may be used for calculating depth and for enhancing the precision of the 3D imaging of the area of the patient's body. In some embodiments, the wavelength of the pattern may be in the visible or the infrared range.

In some embodiments, the system may comprise a structured light projector (not shown) mounted on a wall or on an arm of the operating room. In such embodiments, a calibration process between the structured light projector and one or more cameras on the head-mounted unit or elsewhere in the operating room may be performed to obtain the 3D map.

In some embodiments, the systems and methods for depth sensing described herein and/or in PCT International Application Publication No. WO2023/021448 may be used to measure the distance between professional 26 and a tracked element of the scene, such as marker 62. For example, a distance sensor comprising a depth sensor configured to illuminate the ROI with a pattern of structured light (e.g., via a structured light projector) can capture and process or analyze an image of the pattern on the ROI in order to measure the distance. The distance sensor may comprise a monochromatic pattern projector such as of a visible light color and one or more visible light cameras. Other distance or depth sensing arrangements described herein may also be used. In some embodiments, the measured distance may be used in dynamically determining focus, performing stereo rectification and/or stereoscopic display. These depth sensing systems and methods may be specifically used, for example, to generate a digital loupe for an HMD such as HMD 28 or 70, as described herein.

According to some embodiments, the depth sensing systems and methods described herein and/or in PCT International Application Publication No. WO2023/021448 may be used to monitor change in depth of soft tissue relative to a fixed point to calculate the effect and/or pattern of respiration or movement due to causes other than respiration. In particular, such respiration monitoring may be utilized to improve the registration with the patient anatomy and may make it unnecessary to hold or restrict the patient's breathing. When operating on a patient during surgery, patient breathing causes movement of the soft tissues, which in turn can cause movement of some of the bones. For example, when an anchoring device such as a clamp is rigidly fixed to a bone, this bone does not move relative to the clamp, but other bones may. A depth sensor or using depth sensing to measure the depth of one or more pixels (e.g., every pixel) in an image may allow identifying a reference point (e.g., the clamp or a point on the bone the clamp is attached to) and monitoring of the changing depth of any point relative to the reference point. The change in depth of soft tissue close to a bone may be correlated with movement of the bone using this information, and then this offset may be used, inter alia, as a correction of the registration or to warn of possible large movement. Visual and/or audible warnings or alerts may be generated and/or displayed. Alternatively, or additionally, the depth sensing systems and methods described herein may be used to directly track change in depth of bones and not via soft-tissue changes.

According to some embodiments, identifying change in depth of soft tissue at the tip of a surgical or medical instrument via the depth sensing described herein and/or in PCT International Application Publication No. WO2023/021448 may be used as a measure of the amount of force applied. Depth sensing may be used in place of a haptic sensor and may provide feedback to a surgeon or other medical professionals (e.g., for remote procedures or robotic use in particular). For example, in robotic surgery the amount of pressure applied by the robot may be a very important factor to control and replaces the surgeon's feel (haptic feedback). To provide haptic feedback, a large force sensor at the tip of the instrument may be required. According to some embodiments, the instrument tip may be tracked (e.g., navigated or tracked using computer vision) and depth sensing techniques may be used to determine the depth of one or more pixels (e.g., every pixel) to monitor the change in depth of the soft tissue at the instrument tip, thus avoiding the need for a large, dedicated force sensor for haptic, or pressure, sensing. Very large quick changes may either be the instrument moving towards the tissue or cutting into it; however, small changes may be correlated to the pressure being applied. Such monitoring may be used to generate a function that correlates change in depth at the instrument tip to force and use this information for haptic feedback.

### Additional Information

The processors 45, 52 may include one or more central processing units (CPUs) or processors, which may each include a conventional or proprietary microprocessor. The processors 45, 52 may be communicatively coupled to one or more memory units, such as random-access memory (RAM) for temporary storage of information, one or more read only memory (ROM) for permanent storage of information, and one or more mass storage devices, such as a hard drive, diskette, solid state drive, or optical media storage device. The processors 45, 52 (or memory units communicatively coupled thereto) may include modules comprising program instructions or algorithm steps configured for execution by the processors 45, 52 to perform any of all of the processes or algorithms discussed herein. The processors 45, 52 may be communicatively coupled to external devices (e.g., display devices, data storage devices, databases, servers, etc. over a network via a network communications interface.

In general, the word “module,” as used herein, refers to logic embodied in hardware or firmware, or to a collection of software instructions, possibly having entry and exit points, written in a programming language, such as, for example, Java, Lua, C, C#, or C++. A software module or product may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, or any other tangible medium. Such software code may be stored, partially or fully, on a memory device of the executing computing device, such as the processors 45, 52, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules but may be represented in hardware or firmware. Generally, any modules or programs or flowcharts described herein may refer to logical modules that may be combined with other modules or divided into sub-modules despite their physical organization or storage.

Although the drawings relate specifically to surgery on the spine, the principles of the present disclosure may similarly be applied in loupes for other sorts of medical and dental procedures, as well loupes for other applications, such as but not limited to arthroscopic procedures (including joint replacement, such as hip replacement, knee replacement, shoulder joint replacement or ankle joint replacement; reconstructive surgery (e.g., hip surgery, knee surgery, ankle surgery, foot surgery); joint fusion surgery; laminectomy; osteotomy; neurologic surgery (e.g., brain surgery, spinal cord surgery, peripheral nerve procedures); ocular surgery; urologic surgery; cardiovascular surgery (e.g., heart surgery, vascular intervention); oncology procedures; biopsies; tendon or ligament repair; and/or organ transplants.

In the foregoing specification, the systems and processes have been described with reference to specific embodiments thereof. It will, however, be evident that various modifications and changes may be made thereto without departing from the broader spirit and scope of the embodiments disclosed herein. The specification and drawings are, accordingly, to be regarded in an illustrative rather than restrictive sense.

Indeed, although the systems and processes have been disclosed in the context of certain embodiments and examples, it will be understood by those skilled in the art that the various embodiments of the systems and processes extend beyond the specifically disclosed embodiments to other alternative embodiments and/or uses of the systems and processes and obvious modifications and equivalents thereof. In addition, while several variations of the embodiments of the systems and processes have been shown and described in detail, other modifications, which are within the scope of this disclosure, will be readily apparent to those of skill in the art based upon this disclosure. It is also contemplated that various combinations or sub-combinations of the specific features and aspects of the embodiments may be made and still fall within the scope of the disclosure. It should be understood that various features and aspects of the disclosed embodiments can be combined with, or substituted for, one another in order to form varying modes of the embodiments of the disclosed systems and processes. Any methods disclosed herein need not be performed in the order recited. Thus, it is intended that the scope of the systems and processes herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and sub-combinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. No single feature or group of features is necessary or indispensable to each and every embodiment.

Each of the processes, methods, and algorithms described in the preceding sections may be embodied in, and fully or partially automated by, code modules executed by one or more computer systems or computer processors comprising computer hardware. The code modules may be stored on any type of non-transitory computer-readable medium or computer storage device, such as hard drives, solid state memory, optical disc, and/or the like. The systems and modules may also be transmitted as generated data signals (for example, as part of a carrier wave or other analog or digital propagated signal) on a variety of computer-readable transmission mediums, including wireless-based and wired/cable-based mediums, and may take a variety of forms (for example, as part of a single or multiplexed analog signal, or as multiple discrete digital packets or frames). The processes and algorithms may be implemented partially or wholly in application-specific circuitry. The results of the disclosed processes and process steps may be stored, persistently or otherwise, in any type of non-transitory computer storage such as, for example, volatile or non-volatile storage.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one or more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

The term “simultaneously” as used herein may refer to operations performed at the same time or substantially at the same time or in a predefined time interval, e.g., a time interval considered as the same time via human perception.

The term “image” or “images” as used herein may include, but not limited to, two-dimensional images, three-dimensional images, two-dimensional or three-dimensional models, still images, video images, computer-generated images (e.g., virtual images, icons, virtual representations etc.), or camera generated images.

As used herein “generate” or “generating” may include specific algorithms for creating information based on or using other input information. Generating may include retrieving the input information such as from memory or as provided input parameters to the hardware performing the generating. Once obtained, the generating may include combining the input information. The combination may be performed through specific circuitry configured to provide an output indicating the result of the generating. The combination may be dynamically performed such as through dynamic selection of execution paths based on, for example, the input information, device operational characteristics (for example, hardware resources available, power level, power source, memory levels, network connectivity, bandwidth, and the like). Generating may also include storing the generated information in a memory location. The memory location may be identified as part of the request message that initiates the generating. In some implementations, the generating may return location information identifying where the generated information can be accessed. The location information may include a memory location, network locate, file system location, or the like.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

All of the methods and processes described above may be embodied in, and partially or fully automated via, software code modules executed by one or more general purpose computers. For example, the methods described herein may be performed by the processors 45, 52 and/or any other suitable computing device. The methods may be executed on the computing devices in response to execution of software instructions or other executable code read from a tangible computer readable medium. A tangible computer readable medium is a data storage device that can store data that is readable by a computer system. Examples of computer readable mediums include read-only memory, random-access memory, other volatile or non-volatile memory devices, CD-ROMs, magnetic tape, flash drives, and optical data storage devices.

The section headings used herein are merely provided to enhance readability and are not intended to limit the scope of the embodiments disclosed in a particular section to the features or elements disclosed in that section.

### APPENDIX

The following provides an analytic expression for Δα, and uses the equivalences:

$$\begin{matrix}x ≡ tan ( Δα ) , & A ≡ tan ( \frac{α}{2} ) , & C ≡ \frac{b}{d}\end{matrix} \qquad ( A 1 )$$

where Δα, a, b, and d are as defined above with respect to FIGS. 7A, 7B, and 7C.

Referring to FIG. 7C, construction line O_{S}L_{S} is assumed to cut plane 204 at Z, and the optical axis of camera 43R is assumed to cut plane 204 at T.

$$Q Z = Q S + S Z = d \cdot tan ( \frac{α}{2} - Δ α ) + \frac{b}{2} and QZ = Q T - Z T = d \cdot tan ( \frac{α}{2} + Δ α ) - \frac{b}{2} \qquad ( A2 )$$

Equating the two expressions for QZ, rearranging, and using the equivalences of (A1), gives the following expression:

$$\begin{matrix}C = \frac{A + x}{1 - A \cdot x} - \frac{A - x}{1 + A \cdot x} & ; 1 - A \cdot x \neq 0 and 1 + A \cdot x \neq 0\end{matrix} \qquad ( A3 )$$

Expression (A3) may be rearranged to give the following quadratic equation in x:

$$C {A}^{2} {x}^{2} + x ( 2 + 2 {A}^{2} ) - C = 0 \qquad ( A4 )$$

A solution for x is:

$$x = \frac{- ( 2 + 2 {A}^{2} ) + \sqrt{{( 2 + 2 {A}^{2} )}^{2} + 4 {C}^{2} {A}^{2}}}{2 C {A}^{2}} \qquad ( A5 )$$

So an expression for Δα is:

$$Δ α = arc tan ( \frac{- ( 2 + 2 {A}^{2} ) + \sqrt{{( 2 + 2 {A}^{2} )}^{2} + 4 {C}^{2} {A}^{2}}}{2 C {A}^{2}} ) \qquad ( A6 )$$

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods can be practiced in many ways. As it is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated. While the embodiments provide various features, examples, screen displays, user interface features, and analyses, it is recognized that other embodiments may be used.

What is claimed is:

1. A head-mounted display device (HMD) comprising:
a display comprising a left see-through display and a right see-through display;
a left digital camera and a right digital camera, separated by a predefined fixed separation and having common predefined angular fields of view (AFOVs), and respectively having a left image sensor and a right image sensor, wherein:
the left digital camera and the right digital camera are configured to be disposed on a plane substantially parallel to a coronal plane of a head of a user wearing the HMD, and configured to be positioned symmetrically with respect to a longitudinal plane of the head of the user wearing the HMD, and
the left digital camera is configured to capture images of a planar field of view (FOV) with a first region of the left image sensor, and the right digital camera is configured to capture images of the planar FOV with a second region of the right image sensor, the planar FOV being formed by the AFOVs intersecting an imaged plane substantially parallel to the coronal plane; and
at least one processor configured to:
obtain a distance from the HMD to the planar FOV;
determine bounds of the planar FOV based at least partially on the distance from the HMD to the planar FOV;
horizontally shift the first region of the left image sensor and the second region of the right image sensor by a common shift, so that respective shifted left and shifted right images generated by the shifted first region and shifted second region are substantially identical and comprise respective shifted portions of the planar FOV, and
present the shifted left image on the left see-through display and the shifted right image on the right see-through display.

2. The HMD according to claim 1, wherein the shifted first region corresponds to a first image AFOV and the shifted second region corresponds to a second image AFOV, and wherein sizes of the first image AFOV and the second image AFOV are smaller than a size of the common predefined AFOVs.

3. The HMD according to claim 2, wherein the horizontal shift of the first region of the left image sensor and the second region of the right image sensor is such that an intersection line of a horizontal first image AFOV with the planar FOV is identical to an intersection line of a horizontal second image AFOV with the planar FOV, wherein the horizontal first image AFOV is a horizontal portion of the first image AFOV and the horizontal second image AFOV is a horizontal portion of the second image AFOV.

4. The HMD according to claim 1, wherein the at least one processor is further configured to magnify the shifted first image and the shifted second image by an input ratio and present magnified shifted first and second images on the left and right see-through displays, respectively.

5. The HMD according to claim 4, wherein the at least one processor is further configured to cause at least one of visibility or clarity of reality through the left and right see-through displays to be reduced when the magnified shifted first and second images are presented.

6. The HMD according to claim 4, further comprising one or more removably couplable neutral density filters configured to reduce transmission of environmental light through the left and right see-through displays when coupled thereto.

7. The HMD according to claim 1, wherein the at least one processor is configured to determine the common shift based at least partially on the distance from the HMD to the planar FOV.

8. The HMD according to claim 1, wherein the left and right digital cameras are positioned in a parallel arrangement, such that an optical axis of the left digital camera and an optical axis of the right digital camera are configured to be parallel to a longitudinal plane of the head of the user.

9. The HMD according to claim 1, wherein the left and right digital cameras are positioned in a toe-in arrangement, such that an optical axis of the left digital camera intersects an optical axis of the right digital camera.

10. The HMD according to claim 9, wherein the at least one processor is configured to determine the common shift based at least partially on the distance from the HMD to the planar FOV and a cross-ratio function initialized by analyzing a target at multiple positions each a different distance from the left and right digital cameras.

11. The HMD according to claim 1, wherein the at least one processor is configured to obtain the distance from the HMD to the planar FOV by at least one of: analyzing disparity between images from the left digital camera and the right digital camera, or computing the distance based on a focus of the left digital camera or the right digital camera.

12. The HMD according to claim 1, wherein the at least one processor is configured to obtain the distance from the HMD to the planar FOV by analyzing one or more images of at least one optical marker located in or adjacent to the planar FOV.

13. The HMD according to claim 1, wherein the at least one processor is configured to obtain the distance from the HMD to the planar FOV by, based on signals provided by one or more eye trackers, comparing gaze angles of left and right eyes of the user to find a distance at which the eyes converge.

14. The HMD according to claim 1, further comprising a distance sensor for measuring the distance from the HMD to the planar FOV, wherein the distance sensor comprises a camera configured to capture images of at least one optical marker.

15. The HMD according to claim 1, further comprising a distance sensor for measuring the distance from the HMD to the planar FOV, wherein the distance sensor comprises a depth sensor configured to illuminate the planar FOV with a pattern of structured light and analyze an image of the pattern on the planar FOV.

16. The HMD according to claim 1, wherein the common shift rotates the AFOV of the left digital camera by a first angular rotation, and the AFOV of the right digital camera by a second angular rotation equal numerically and opposite in direction to the first angular rotation.

17. The HMD according to claim 16, wherein the AFOV of the left digital camera and of the right digital camera after the first and the second angular rotations is numerically equal to the AFOV of the left digital camera and of the right digital camera before the angular rotations.

18. The HMD according to claim 16, wherein the planar FOV comprises a left planar FOV formed in response to the AFOV of the left digital camera intersecting the imaged plane and a right planar FOV formed in response to the AFOV of the right digital camera intersecting the imaged plane, and wherein a left metric defining a length of the left planar FOV is numerically equal to a right metric defining a length of the right planar FOV.

19. A head mounted display device (HMD) comprising:
a display comprising a first display and a second display;
a first and a second digital cameras, respectively comprising a first image sensor and a second image sensor, and respectively having a first and a second predetermined angular fields of view (AFOVs), wherein the first and second digital cameras are being disposed in a predetermined fixed setup on a plane substantially parallel to a frontal plane of a head of a user wearing the HMD, the first and second digital cameras separated by a predetermined fixed separation defining one of the first or second digital cameras as a left camera and the other as a right camera with respect to the user; and
at least one processor configured to:
generate a first image and a second image from a first image region of the first image sensor and from a second image region of the second image sensor, respectively, wherein:
the first image region corresponds to a first image AFOV, and the second image region corresponds to a second image AFOV,
sizes of the first image AFOV and the second image AFOV are equal to a predefined image AFOV size smaller than a size of each of the first and second AFOVs, and
the first image AFOV and the second image AFOV are symmetrical with respect to a longitudinal plane of the head of the user;
obtain a distance between the HMD and a Region of Interest (ROI) plane, wherein the ROI plane is substantially parallel to the frontal plane;
change at least one of the first image region of the first image sensor or the second image region of the second image sensor based on the obtained distance, so that for a first image and a second image generated based on the change from the first and second image regions, respectively, a portion of the ROI plane imaged by the first image is substantially identical to a portion of the ROI plane imaged by the second image; and
simultaneously display the first image on the first display and the second image on the second display.

20. A method, comprising using a head-mounted display device according to claim 1 to perform a diagnostic procedure or a surgical intervention on a spine, cranium, jaw, or orthopedic joint.
